(19) United States
(12) Patent Application Publication
(10) Pub. No.: US 2025/0008567 A1
(43) Pub. Date: Jan. 2, 2025

(54) TECHNIQUES FOR DYNAMIC RESOURCE ALLOCATION

(71) Applicant: QUALCOMM INCORPORATED, San Diego, CA (US)

(72) Inventors: Jing Lei, San Diego, CA (US); Jing Jiang, San Diego, CA (US); Ruiming Zheng, Beijing (CN)

(21) Appl. No.: 18/725,562

(22) PCT Filed: Feb. 18, 2022
(86) PCT No.: PCT/CN2022/076759

§ 371 Date: Jun. 28, 2024

(51) Int. Cl. H04W 74/0833; H04W 72/044

(52) U.S. Cl. CPC H04W 74/0833; H04W 72/044

(57) ABSTRACT

Methods, systems, and devices for wireless communications are described. A user equipment (UE) may receive system information indicating a first set of resources allocated for transmission of random access messages and a second set of resources for requesting on-demand signaling. The UE may transmit a random access message via the first set of resources, and may transmit a request for on-demand signaling via the second set of resources. Upon receiving the random access message, a network entity may transmit a random access response (RAR) indicating a third set of resources allocated for reception of random access messages. Upon receiving the request, the network entity may transmit an indication of a fourth set of resources allocated for transmission of the on-demand signaling. Accordingly, the UE may retransmit the random access message via the third set of resources, and may receive the on-demand signaling via the fourth set of resources.

### CROSS REFERENCE

The present Application is a 371 national stage filing of International PCT Application No. PCT/CN2022/076759 by Lei et al. entitled “TECHNIQUES FOR DYNAMIC RESOURCE ALLOCATION,” filed Feb. 18, 2022, which is assigned to the assignee hereof, and which is expressly incorporated by reference in its entirety herein.

### TECHNICAL FIELD

The following relates to wireless communications, including techniques for dynamic resource allocation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Components within a wireless communication system may be coupled (for example, operatively, communicatively, functionally, electronically, and/or electrically) to each other.

In some wireless communications systems, a UE may initiate a random access procedure by transmitting a random access preamble to a network entity on resources that are configured via system information. In some cases, however, multiple UEs may transmit random access preambles on the same resources, which may result in collisions, latency, and decreased communication reliability.

### SUMMARY

The described techniques relate to improved methods, systems, devices, and apparatuses that support techniques for dynamic resource allocation. For example, the described techniques provide for improving initial access procedures between a user equipment (UE) and a network entity. In accordance with aspects of the present disclosure, a UE may receive system information indicating a first set of resources allocated for transmission of random access messages, a second set of resources for requesting on-demand signaling, or both. Accordingly, the UE may transmit a random access message via the first set of resources, and may transmit a request for on-demand signaling via the second set of resources. Upon receiving the random access message, a network entity may transmit a random access response (RAR) indicating a third set of resources (e.g., different from the first set of resources) allocated for reception of random access messages. Upon receiving the request, the network entity may transmit an indication of a fourth set of resources allocated for transmission of the on-demand signaling. Accordingly, the UE may retransmit the random access message via the third set of resources, and may receive the on-demand signaling via the fourth set of resources.

A method for wireless communications at a UE is described. The method may include receiving, in a first downlink bandwidth part (BWP), system information indicating a first set of resources allocated for transmission of random access messages in a first uplink BWP, transmitting a random access message via the first set of resources in accordance with the system information, receiving a RAR indicating a second set of resources that are different from the first set of resources, and transmitting a retransmission of the random access message via the second set of resources in accordance with the RAR.

An apparatus for wireless communications at a UE is described. The apparatus may include at least one processor, memory coupled (e.g., operatively, communicatively, functionally, electronically, or electrically) with the at least one processor, and instructions stored in the memory. The instructions may be executable by the at least one processor to cause the apparatus to receive, in a first downlink BWP, system information indicating a first set of resources allocated for transmission of random access messages in a first uplink BWP, transmit a random access message via the first set of resources in accordance with the system information, receive a RAR indicating a second set of resources that are different from the first set of resources, and transmit a retransmission of the random access message via the second set of resources in accordance with the RAR.

Another apparatus for wireless communications at a UE is described. The apparatus may include means for receiving, in a first downlink BWP, system information indicating a first set of resources allocated for transmission of random access messages in a first uplink BWP, means for transmitting a random access message via the first set of resources in accordance with the system information, means for receiving a RAR indicating a second set of resources that are different from the first set of resources, and means for transmitting a retransmission of the random access message via the second set of resources in accordance with the RAR.

A non-transitory computer-readable medium storing code for wireless communications at a UE is described. The code may include instructions executable by at least one processor to receive, in a first downlink BWP, system information indicating a first set of resources allocated for transmission of random access messages in a first uplink BWP, transmit a random access message via the first set of resources in accordance with the system information, receive a RAR indicating a second set of resources that are different from the first set of resources, and transmit a retransmission of the random access message via the second set of resources in accordance with the RAR.

In some examples of the method, apparatuses, and non-transitory computer-readable medium described herein, receiving the RAR may include operations, features, means, or instructions for receiving the RAR indicating the second set of resources and a time duration in which the second set of resources may be available for retransmission of random access messages.

In some examples of the method, apparatuses, and non-transitory computer-readable medium described herein, receiving the RAR may include operations, features, means, or instructions for receiving the RAR indicating the second set of resources that may be multiplexed with the first set of resources in a time domain, a frequency domain, a space domain, or a combination thereof.

In some examples of the method, apparatuses, and non-transitory computer-readable medium described herein, receiving the RAR may include operations, features, means, or instructions for receiving the RAR indicating the second set of resources in the first uplink BWP or in a second uplink BWP that may be different from the first uplink BWP.

In some examples of the method, apparatuses, and non-transitory computer-readable medium described herein, receiving the RAR may include operations, features, means, or instructions for receiving the RAR indicating the second set of resources and a random access signature that includes one or more of a random access preamble identifier (RAPID), a UE identifier, or a temporary identifier associated with a random access resource, where transmitting the retransmission of the random access message may be based on comparing the random access signature from the RAR to a random access signature associated with the random access message.

In some examples of the method, apparatuses, and non-transitory computer-readable medium described herein, receiving the RAR may include operations, features, means, or instructions for receiving the RAR indicating a random access resource pool that includes the second set of resources, where transmitting the retransmission of the random access message via the second set of resources may be based on selecting the second set of resources from the random access resource pool.

Some examples of the method, apparatuses, and non-transitory computer-readable medium described herein may further include operations, features, means, or instructions for receiving a multicast or broadcast downlink control channel transmission indicating one or more resources allocated for reception of the RAR, where the multicast or broadcast downlink control channel transmission includes group-common downlink control information and monitoring the one or more resources for the RAR in accordance with the multicast or broadcast downlink control channel transmission, where the RAR may be scrambled using a group identifier.

In some examples of the method, apparatuses, and non-transitory computer-readable medium described herein, transmitting the retransmission of the random access message may include operations, features, means, or instructions for transmitting the retransmission of the random access message via the second set of resources in accordance with a power ramping scheme, a beam switching scheme, an antenna switching scheme, a BWP switching scheme, a carrier switching scheme, a random backoff scheme, a frequency hopping scheme, a coverage enhancement scheme, or a combination thereof.

A method for wireless communications at a network entity is described. The method may include transmitting, in a first downlink BWP, system information indicating a first set of resources allocated for reception of random access messages in a first uplink BWP, monitoring the first set of resources for a random access message in accordance with the system information, transmitting a RAR based on monitoring the first set of resources, the RAR indicating a second set of resources that are different from the first set of resources, and monitoring the second set of resources for a retransmission of the random access message in accordance with the RAR.

An apparatus for wireless communications at a network entity is described. The apparatus may include at least one processor, memory coupled (e.g., operatively, communicatively, functionally, electronically, or electrically) with the at least one processor, and instructions stored in the memory. The instructions may be executable by the at least one processor to cause the apparatus to transmit, in a first downlink BWP, system information indicating a first set of resources allocated for reception of random access messages in a first uplink BWP, monitor the first set of resources for a random access message in accordance with the system information, transmit a RAR based on monitoring the first set of resources, the RAR indicating a second set of resources that are different from the first set of resources, and monitor the second set of resources for a retransmission of the random access message in accordance with the RAR.

Another apparatus for wireless communications at a network entity is described. The apparatus may include means for transmitting, in a first downlink BWP, system information indicating a first set of resources allocated for reception of random access messages in a first uplink BWP, means for monitoring the first set of resources for a random access message in accordance with the system information, means for transmitting a RAR based on monitoring the first set of resources, the RAR indicating a second set of resources that are different from the first set of resources, and means for monitoring the second set of resources for a retransmission of the random access message in accordance with the RAR.

A non-transitory computer-readable medium storing code for wireless communications at a network entity is described. The code may include instructions executable by at least one processor to transmit, in a first downlink BWP, system information indicating a first set of resources allocated for reception of random access messages in a first uplink BWP, monitor the first set of resources for a random access message in accordance with the system information, transmit a RAR based on monitoring the first set of resources, the RAR indicating a second set of resources that are different from the first set of resources, and monitor the second set of resources for a retransmission of the random access message in accordance with the RAR.

In some examples of the method, apparatuses, and non-transitory computer-readable medium described herein, transmitting the RAR may include operations, features, means, or instructions for transmitting the RAR indicating the second set of resources and a time duration in which the second set of resources may be available for retransmission of random access messages.

In some examples of the method, apparatuses, and non-transitory computer-readable medium described herein, transmitting the RAR may include operations, features, means, or instructions for transmitting the RAR indicating the second set of resources that may be multiplexed with the first set of resources in a time domain, a frequency domain, a space domain, or a combination thereof.

In some examples of the method, apparatuses, and non-transitory computer-readable medium described herein, transmitting the RAR may include operations, features, means, or instructions for transmitting the RAR indicating the second set of resources in the first uplink BWP or in a second uplink BWP that may be different from the first uplink BWP.

In some examples of the method, apparatuses, and non-transitory computer-readable medium described herein, transmitting the RAR may include operations, features, means, or instructions for transmitting the RAR indicating the second set of resources and a random access signature that includes one or more of a RAPID, a UE identifier, or a temporary identifier associated with a random access resource.

In some examples of the method, apparatuses, and non-transitory computer-readable medium described herein, transmitting the RAR may include operations, features, means, or instructions for transmitting the RAR indicating a random access resource pool that includes the second set of resources.

Some examples of the method, apparatuses, and non-transitory computer-readable medium described herein may further include operations, features, means, or instructions for transmitting a multicast or broadcast downlink control channel transmission indicating one or more resources allocated for transmission of the RAR, where the multicast or broadcast downlink control channel transmission includes group-common downlink control information and transmitting the RAR via the one or more resources in accordance with the multicast or broadcast downlink control channel transmission, where the RAR may be scrambled using a group identifier.

Some examples of the method, apparatuses, and non-transitory computer-readable medium described herein may further include operations, features, means, or instructions for receiving the retransmission of the random access message via the second set of resources in accordance with a power ramping scheme, a beam switching scheme, an antenna switching scheme, a BWP switching scheme, a carrier switching scheme, a random backoff scheme, a frequency hopping scheme, a coverage enhancement scheme, or a combination thereof.

A method for wireless communications at a UE is described. The method may include receiving, in a first downlink BWP, system information indicating a first set of resources for requesting on-demand signaling, transmitting, in a first uplink BWP and via the first set of resources, a request for the on-demand signaling, receiving an indication of a second set of resources allocated for reception of the on-demand signaling, and monitoring the second set of resources for the on-demand signaling in accordance with the indication.

An apparatus for wireless communications at a UE is described. The apparatus may include at least one processor, memory coupled (e.g., operatively, communicatively, functionally, electronically, or electrically) with the at least one processor, and instructions stored in the memory. The instructions may be executable by the at least one processor to cause the apparatus to receive, in a first downlink BWP, system information indicating a first set of resources for requesting on-demand signaling, transmit, in a first uplink BWP and via the first set of resources, a request for the on-demand signaling, receive an indication of a second set of resources allocated for reception of the on-demand signaling, and monitor the second set of resources for the on-demand signaling in accordance with the indication.

Another apparatus for wireless communications at a UE is described. The apparatus may include means for receiving, in a first downlink BWP, system information indicating a first set of resources for requesting on-demand signaling, means for transmitting, in a first uplink BWP and via the first set of resources, a request for the on-demand signaling, means for receiving an indication of a second set of resources allocated for reception of the on-demand signaling, and means for monitoring the second set of resources for the on-demand signaling in accordance with the indication.

A non-transitory computer-readable medium storing code for wireless communications at a UE is described. The code may include instructions executable by at least one processor to receive, in a first downlink BWP, system information indicating a first set of resources for requesting on-demand signaling, transmit, in a first uplink BWP and via the first set of resources, a request for the on-demand signaling, receive an indication of a second set of resources allocated for reception of the on-demand signaling, and monitor the second set of resources for the on-demand signaling in accordance with the indication.

In some examples of the method, apparatuses, and non-transitory computer-readable medium described herein, receiving the system information may include operations, features, means, or instructions for receiving, in the first downlink BWP, the system information that indicates one or both of the first set of resources or the second set of resources.

In some examples of the method, apparatuses, and non-transitory computer-readable medium described herein, receiving the indication of the second set of resources may include operations, features, means, or instructions for receiving a RAR indicating an activation status of the second set of resources, an availability of the second set of resources, or both.

In some examples of the method, apparatuses, and non-transitory computer-readable medium described herein, transmitting the request may include operations, features, means, or instructions for transmitting, via the first set of resources, a random access message including the request for the on-demand signaling.

Some examples of the method, apparatuses, and non-transitory computer-readable medium described herein may further include operations, features, means, or instructions for receiving, via the second set of resources, the on-demand signaling that includes a system information block (SIB), a synchronization signal block (SSB), a set of reference signals, a broadcast channel transmission, timing information associated with the on-demand signaling (e.g., a timer controlling the presence of the on-demand signaling), or a combination thereof.

Some examples of the method, apparatuses, and non-transitory computer-readable medium described herein may further include operations, features, means, or instructions for receiving, via the second set of resources, the on-demand signaling that indicates a set of uplink resources, a set of downlink resources, a set of measurement objects, a set of random access resources allocated for retransmission of random access messages, or a combination thereof.

In some examples of the method, apparatuses, and non-transitory computer-readable medium described herein, the on-demand signaling indicates the set of random access resources and the method, apparatuses, and non-transitory computer-readable medium may include further operations, features, means, or instructions for transmitting a retransmission of a random access message via the set of random access resources indicated by the on-demand signaling.

Some examples of the method, apparatuses, and non-transitory computer-readable medium described herein may further include operations, features, means, or instructions for receiving a set of multiple repetitions of the on-demand signaling via the second set of resources.

Some examples of the method, apparatuses, and non-transitory computer-readable medium described herein may further include operations, features, means, or instructions for receiving the on-demand signaling in the first downlink BWP or in a second downlink BWP that may be different from the first downlink BWP.

In some examples of the method, apparatuses, and non-transitory computer-readable medium described herein, receiving the indication of the second set of resources may include operations, features, means, or instructions for receiving the indication of a radio resource mapping between the second set of resources and the on-demand signaling, the radio resource mapping associated with a capability of the UE, a service type of the UE, a link quality of the UE, or a combination thereof.

In some examples of the method, apparatuses, and non-transitory computer-readable medium described herein, the radio resource mapping indicates one or more of a synchronization raster, a channel raster, or a repetition pattern associated with the capability of the UE, the service type of the UE, the link quality of the UE, or a combination thereof.

Some examples of the method, apparatuses, and non-transitory computer-readable medium described herein may further include operations, features, means, or instructions for performing one or more of a BWP switching procedure, a carrier switching procedure, a beam switching procedure, an antenna switching procedure, a random backoff procedure, a frequency hopping procedure, or a coverage enhancement procedure based on receiving the on-demand signaling via the second set of resources.

Some examples of the method, apparatuses, and non-transitory computer-readable medium described herein may further include operations, features, means, or instructions for receiving an indication that the on-demand signaling, the second set of resources, or both may be specific to a capability of the UE, a service type of the UE, a coverage level of the UE, a link quality of the UE, a contention resolution status of the UE, or a combination thereof.

In some examples of the method, apparatuses, and non-transitory computer-readable medium described herein, receiving the system information may include operations, features, means, or instructions for receiving the system information indicating the first set of resources for requesting the on-demand signaling, the first set of resources including dedicated resources associated with a capability of the UE, a service type of the UE, a link quality of the UE, or a combination thereof.

In some examples of the method, apparatuses, and non-transitory computer-readable medium described herein, receiving the indication of the second set of resources may include operations, features, means, or instructions for receiving a paging message in a paging occasion (PO) associated with a capability of the UE, a service type of the UE, a link quality of the UE, or a combination thereof, where the paging message includes the indication of the second set of resources.

A method for wireless communications at a network entity is described. The method may include transmitting, in a first downlink BWP, system information indicating a first set of resources for requesting transmission of on-demand signaling, receiving, in a first uplink BWP and via the first set of resources, a request for the on-demand signaling, transmitting an indication of a second set of resources allocated for transmission of the on-demand signaling, and transmitting the on-demand signaling via the second set of resources in accordance with the indication.

An apparatus for wireless communications at a network entity is described. The apparatus may include at least one processor, memory coupled (e.g., operatively, communicatively, functionally, electronically, or electrically) with the at least one processor, and instructions stored in the memory. The instructions may be executable by the at least one processor to cause the apparatus to transmit, in a first downlink BWP, system information indicating a first set of resources for requesting transmission of on-demand signaling, receive, in a first uplink BWP and via the first set of resources, a request for the on-demand signaling, transmit an indication of a second set of resources allocated for transmission of the on-demand signaling, and transmit the on-demand signaling via the second set of resources in accordance with the indication.

Another apparatus for wireless communications at a network entity is described. The apparatus may include means for transmitting, in a first downlink BWP, system information indicating a first set of resources for requesting transmission of on-demand signaling, means for receiving, in a first uplink BWP and via the first set of resources, a request for the on-demand signaling, means for transmitting an indication of a second set of resources allocated for transmission of the on-demand signaling, and means for transmitting the on-demand signaling via the second set of resources in accordance with the indication.

A non-transitory computer-readable medium storing code for wireless communications at a network entity is described. The code may include instructions executable by at least one processor to transmit, in a first downlink BWP, system information indicating a first set of resources for requesting transmission of on-demand signaling, receive, in a first uplink BWP and via the first set of resources, a request for the on-demand signaling, transmit an indication of a second set of resources allocated for transmission of the on-demand signaling, and transmit the on-demand signaling via the second set of resources in accordance with the indication.

In some examples of the method, apparatuses, and non-transitory computer-readable medium described herein, transmitting the system information may include operations, features, means, or instructions for transmitting, in the first downlink BWP, the system information indicating one or both of the first set of resources or the second set of resources.

In some examples of the method, apparatuses, and non-transitory computer-readable medium described herein, transmitting the indication of the second set of resources may include operations, features, means, or instructions for transmitting a RAR indicating an activation status of the second set of resources, an availability of the second set of resources, or both.

In some examples of the method, apparatuses, and non-transitory computer-readable medium described herein, receiving the request may include operations, features, means, or instructions for receiving, via the first set of resources, a random access message including the request for the on-demand signaling.

In some examples of the method, apparatuses, and non-transitory computer-readable medium described herein, transmitting the on-demand signaling may include operations, features, means, or instructions for transmitting, via the second set of resources, the on-demand signaling that includes a SIB, an SSB, a set of reference signals, a broadcast channel transmission, timing information associated with the on-demand signaling, or a combination thereof.

In some examples of the method, apparatuses, and non-transitory computer-readable medium described herein, transmitting the on-demand signaling may include operations, features, means, or instructions for transmitting, via the second set of resources, the on-demand signaling that indicates a set of uplink resources, a set of downlink resources, a set of measurement objects, a set of random access resources allocated for reception of random access messages, or a combination thereof.

In some examples of the method, apparatuses, and non-transitory computer-readable medium described herein, the on-demand signaling indicates the set of random access resources and the method, apparatuses, and non-transitory computer-readable medium may include further operations, features, means, or instructions for receiving a retransmission of a random access message via the set of random access resources indicated by the on-demand signaling.

In some examples of the method, apparatuses, and non-transitory computer-readable medium described herein, transmitting the on-demand signaling may include operations, features, means, or instructions for transmitting a set of multiple repetitions of the on-demand signaling via the second set of resources.

In some examples of the method, apparatuses, and non-transitory computer-readable medium described herein, transmitting the on-demand signaling may include operations, features, means, or instructions for transmitting the on-demand signaling in a second downlink BWP that may be different from the first downlink BWP associated with transmission of the system information.

In some examples of the method, apparatuses, and non-transitory computer-readable medium described herein, transmitting the on-demand signaling may include operations, features, means, or instructions for transmitting the on-demand signaling in the first downlink BWP associated with transmission of the system information.

In some examples of the method, apparatuses, and non-transitory computer-readable medium described herein, transmitting the indication of the second set of resources may include operations, features, means, or instructions for transmitting the indication of a radio resource mapping between the second set of resources and the on-demand signaling, the radio resource mapping associated with a UE capability, a service type, a link quality, or a combination thereof.

In some examples of the method, apparatuses, and non-transitory computer-readable medium described herein, the radio resource mapping indicates one or more of a synchronization raster, a channel raster, or a repetition pattern associated with the UE capability, the service type, the link quality, or a combination thereof.

In some examples of the method, apparatuses, and non-transitory computer-readable medium described herein, transmitting the on-demand signaling may include operations, features, means, or instructions for transmitting the on-demand signaling that includes an indication to perform a BWP switching procedure, a carrier switching procedure, a beam switching procedure, an antenna switching procedure, a random backoff procedure, a frequency hopping procedure, or a coverage enhancement procedure.

Some examples of the method, apparatuses, and non-transitory computer-readable medium described herein may further include operations, features, means, or instructions for transmitting an indication that the on-demand signaling, the second set of resources, or both may be specific to a UE capability, a service type, a coverage level, a link quality, a contention resolution status, or a combination thereof.

In some examples of the method, apparatuses, and non-transitory computer-readable medium described herein, transmitting the system information may include operations, features, means, or instructions for transmitting the system information indicating the first set of resources for requesting the on-demand signaling, the first set of resources including dedicated resources associated with a UE capability, a service type, a link quality, or a combination thereof.

In some examples of the method, apparatuses, and non-transitory computer-readable medium described herein, transmitting the indication of the second set of resources may include operations, features, means, or instructions for transmitting a paging message in a PO associated with a UE capability, a service type, a link quality, or a combination thereof, where the paging message includes the indication of the second set of resources.

Some examples of the method, apparatuses, and non-transitory computer-readable medium described herein may further include operations, features, means, or instructions for identifying the request for the on-demand signaling based on monitoring an energy level associated with the first set of resources and determining that the request corresponds to a UE capability, a service type, a link quality, a contention resolution status, a coverage level, or a combination thereof.

### BRIEF DESCRIPTION OF THE DRAWINGS

FIGS. 1 and 2 illustrate examples of wireless communications systems that support techniques for dynamic resource allocation in accordance with one or more aspects of the present disclosure.

FIG. 3 illustrates an example of a resource diagram that supports techniques for dynamic resource allocation in accordance with one or more aspects of the present disclosure.

FIGS. 4A and 4B illustrate examples of process flows that support techniques for dynamic resource allocation in accordance with one or more aspects of the present disclosure.

FIGS. 5 and 6 illustrate examples of process flows that support techniques for dynamic resource allocation in accordance with one or more aspects of the present disclosure.

FIGS. 7 and 8 show block diagrams of devices that support techniques for dynamic resource allocation in accordance with one or more aspects of the present disclosure.

FIG. 9 shows a block diagram of a communications manager that supports techniques for dynamic resource allocation in accordance with one or more aspects of the present disclosure.

FIG. 10 shows a diagram of a system including a device that supports techniques for dynamic resource allocation in accordance with one or more aspects of the present disclosure.

FIGS. 11 and 12 show block diagrams of devices that support techniques for dynamic resource allocation in accordance with one or more aspects of the present disclosure.

FIG. 13 shows a block diagram of a communications manager that supports techniques for dynamic resource allocation in accordance with one or more aspects of the present disclosure.

FIG. 14 shows a diagram of a system including a device that supports techniques for dynamic resource allocation in accordance with one or more aspects of the present disclosure.

FIGS. 15 through 18 show flowcharts illustrating methods that support techniques for dynamic resource allocation in accordance with one or more aspects of the present disclosure.

### DETAILED DESCRIPTION

In some wireless communications systems, an idle or inactive user equipment (UE) may initiate a random access channel (RACH) procedure by transmitting a random access preamble to a network entity via one or more RACH resources. These RACH resources may be indicated via a system information block (SIB), and may be applicable to UEs within a coverage area of the network entity. SIB-configured RACH resources may be relatively inflexible (e.g., fixed), and may not be suitable for networks with fluctuating traffic loads. For example, if multiple UEs simultaneously transmit random access preambles on the same RACH resources, collisions may occur between the random access preambles. These collisions may decrease the likelihood of the network entity successfully receiving and decoding the random access preambles. Moreover, the UEs may be configured to retransmit the random access preambles on the same RACH resources (e.g., if previous transmissions are unsuccessful), which may result in more collisions, higher latency, and greater power consumption.

Aspects of the present disclosure provide for dynamically configuring additional RACH resources that can be used for retransmitting random access preambles and other uplink messages. These dynamically configured RACH resources may be indicated via a random access response (RAR), which may include a message 2 (msg2), a message 4 (msg4), or a message B (msgB). For example, if a UE transmits a message 1 (msg1) via SIB-configured RACH resources, the UE may receive a msg2 indicating a set of dynamically configured RACH resources that the UE can use to retransmit the msg 1 (e.g., if the first attempt is unsuccessful). The dynamically configured RACH resources may be available for a specific time duration, and may be multiplexed (e.g., in time, frequency, or space) with SIB-configured RACH resources. In some examples, the

The techniques described herein may also provide for requesting (e.g., activating) on-demand signaling during initial access procedures. For example, a UE may receive a SIB indicating a first set of resources for requesting on-demand signaling, and may transmit a request for the on-demand signaling via the first set of resources. In response to this request, the UE may receive an indication of a second set of resources allocated for reception of the on-demand signaling. Accordingly, the UE may monitor the second set of resources for the on-demand signaling, which may include a synchronization signal block (SSB), a SIB, a set of reference signals, a broadcast transmission, timing information, or a combination thereof. In some examples, the on-demand signaling may indicate one or more uplink resources, downlink resources, RACH resources, or measurement objects configured for the UE.

Aspects of the present disclosure may be implemented to realize one or more of the following advantages. The described techniques may increase the likelihood of successful RACH procedures between a UE and a network entity by providing the UE with a set of dynamically configured RACH resources that can be used for retransmitting random access messages. Dynamically allocating RACH resources to the UE may enable the UE to perform initial access procedures with fewer collisions, reduced latency, and improved communication reliability, among other benefits. Moreover, the techniques described herein may enable the UE to activate (e.g., trigger) and receive on-demand signaling (e.g., SSBs, SIBs, reference signals) from a network entity during initial access, which may improve the likelihood of successful communications between the UE and the network entity.

Aspects of the disclosure are initially described in the context of wireless communications systems, resource diagrams, and process flows. Aspects of the disclosure are further illustrated by and described with reference to apparatus diagrams, system diagrams, and flowcharts that relate to techniques for dynamic resource allocation.

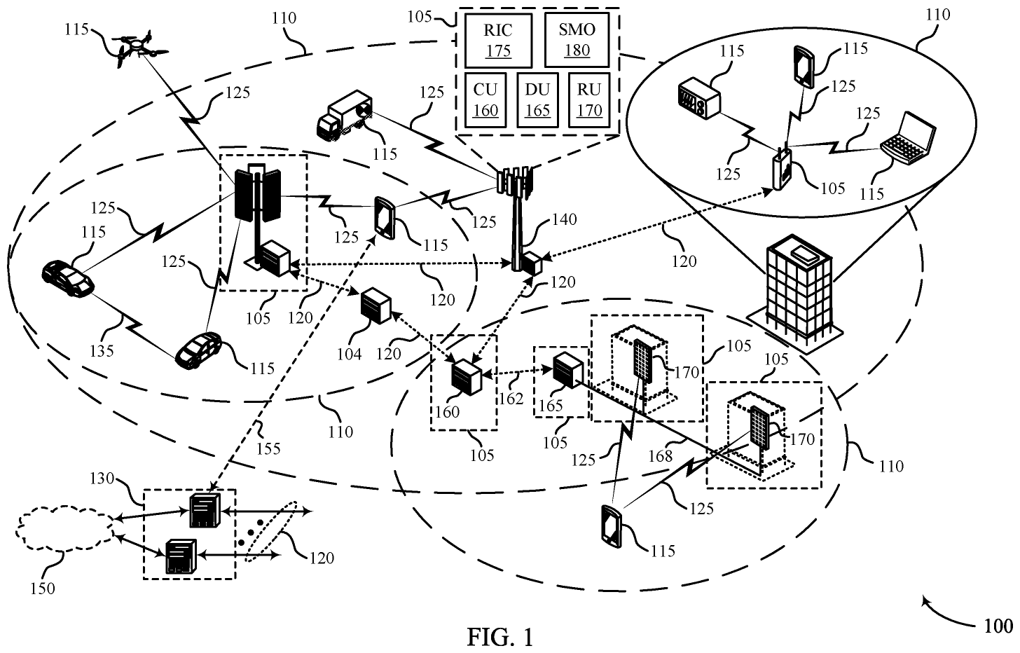

FIG. 1 illustrates an example of a wireless communications system 100 that supports techniques for dynamic resource allocation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RAT).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for dynamic resource allocation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may be a device such as a cellular phone, a smart phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given RAT (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of T_{S}=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). The region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHZ.

The wireless communications system 100 may also operate in a super high frequency (SHF) region using frequency bands from 3 GHz to 30 GHZ, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna array's within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some wireless communications systems that support NR, RACH resources for initial access and other contention-based random access (CBRA) procedures may be provided to a UE 115 via system information. For cells that support different UE types or RACH procedure types, the network may be unable to change the quantity of available RACH resources in response to fluctuating system loads, duplex modes, or UE capabilities. In CBRA, collisions may occur when different UEs select the same RACH resources for RACH transmissions and RACH retransmissions. The techniques and operations described herein may enable UEs 115 to perform initial access procedures, RACH procedures, and system information acquisition procedures with fewer collisions, reduced latency, and greater efficiency. Aspects of the present disclosure may be applicable to wireless communications systems that support different RATs (e.g., 5G-Advanced or sixth generation (6G) RATs), different UE capabilities (e.g., reduced capability (RedCap) UEs), different service types, or a combination thereof.

The wireless communications system 100 may support more efficient utilization of communication resources during initial access procedures between a UE 115 and a network entity 105. More specifically, the techniques and operations described with reference to FIG. 1 may enable a network entity 105 to provide a UE 115 with a set of dynamically configured RACH resources, which the UE 115 may use for transmission (or retransmission) of random access messages. Dynamically allocating RACH resources to the UE 115 may enable the UE 115 to perform initial access procedures with fewer collisions, reduced latency, and improved communication reliability, among other benefits. Moreover, the techniques described herein may enable a UE 115 to activate (e.g., trigger) and receive on-demand signaling from a network entity 105 during initial access, which may improve the likelihood of successful communications between the UE 115 and the network entity 105.

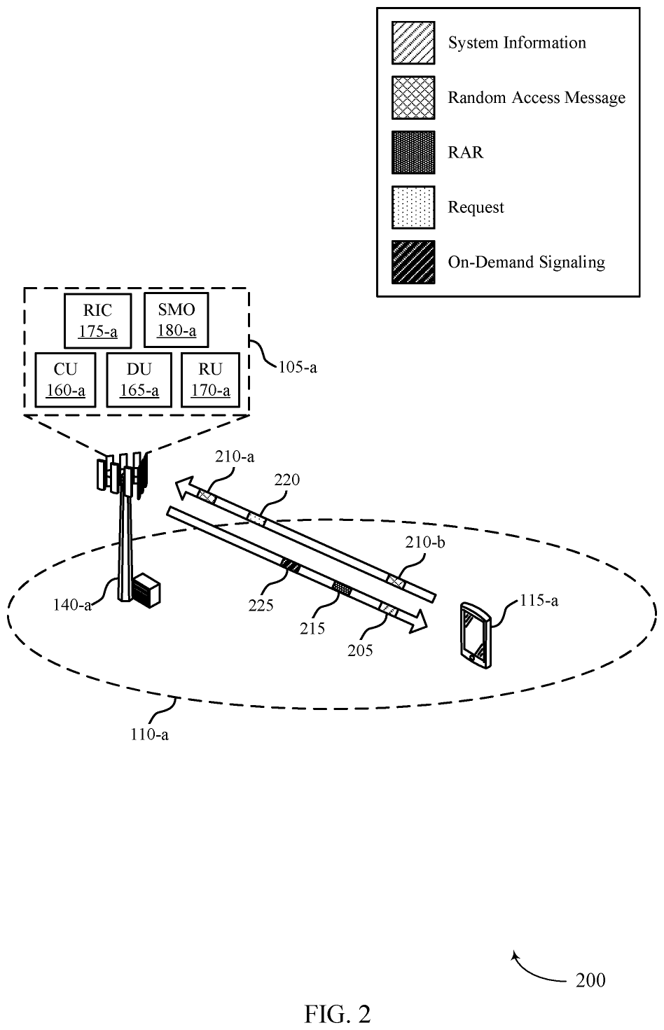

FIG. 2 illustrates an example of a wireless communications system 200 that supports techniques for dynamic resource allocation in accordance with one or more aspects of the present disclosure. The wireless communications system 200 may implement or be implemented by aspects of the wireless communications system 100. For example, the wireless communications system 200 may include a UE 115-a and a network entity 105-a, which may be examples of corresponding devices described with reference to FIG. 1. The UE 115-a and the network entity 105-a may communicate within a coverage area 110-a, which may be an example of a coverage area 110 described with reference to FIG. 1. In the wireless communications system 200, the UE 115-a may retransmit a random access message 210-b using RACH resources from a dynamically configured resource pool.

As described with reference to FIG. 1, the network entity 105-a may include an RIC 175-a, a SMO 180-a, a CU 160-a, a DU 165-a, an RU 170-a, a base station 140-a, or a combination thereof. Communications between the network entity 105-a and the UE 115-a may refer to communications between the UE 115-a and any portion (e.g., entity, sub-entity) of the network entity 105-a. In the following description of the wireless communications system 200, the terms “transmitting,” “receiving,” or “communicating,” when referring to the network entity 105-a, may refer to any portion of the network entity 105-a (e.g., the base station 140-a, the CU 160-a, the DU 165-a, the RU 170-a) communicating with the UE 115-a (e.g., directly or via one or more other network entities 105).

If the UE 115-a is in an idle or inactive mode, the UE 115-a may establish an RRC connection with the network entity 105-a (e.g., a serving cell) by selecting RACH resources indicated by system information 205 and transmitting a random access message 210-a on the selected RACH resources. Additional RACH resources (not indicated in system information) may be allocated to the UE 115-a via a RAR 215, which may be an example of a multicast or broadcast message such as a msg2 RAR, a msg4, a msgB RAR, or any other channel scrambled by a group radio network temporary identifier (RNTI) and scheduled by group common downlink control information (DCI). The RAR 215 may be scheduled by a multicast or broadcast physical downlink control channel (PDCCH) transmission, and may include a response to the random access message 210-a (e.g., an initial uplink transmission on physical RACH (PRACH) resources).

If the UE 115-a decodes the RAR 215 and is unable to find an identifier or signature (e.g. a random access preamble identifier (RAPID) field in a MAC header of the RAR 215, a PRACH preamble, a UE identifier, a RNTI associated with a specific RACH resource) that matches an identifier or signature of the random access message 210-a, the UE 115-a can re-attempt the transmission using additional RACH resources dynamically allocated by the network entity 105-a (e.g., RACH resources indicated by the RAR 215). For example, the UE 115-a can transmit a random access message 210-b (e.g., a retransmission of the random access message 210-a) on dynamically allocated RACH resources.

If the UE 115-a is unable to decode the RAR 215, the UE 115-a can re-attempt PRACH transmissions using a power ramping scheme. Additionally or alternatively, the UE 115-a may select a different RACH resource indicated by the system information 205. The additional RACH resources indicated by the RAR 215 (e.g., a multicast or broadcast message) may be multiplexed (e.g., in time, frequency, space, or code) with SIB-indicated RACH resources (e.g., RACH resources indicated by the system information 205). The dynamic RACH resources and the SIB-configured RACH resources may be located in the same uplink BWP or in different uplink BWPs. The dynamic RACH resources may be available during a specific time duration that is controlled by a timer. An indication of the time duration or timer can be signaled to the UE 115-a in the RAR 215 or via downlink signaling (e.g. DCI, reference signals).

For cells that support different UE types, different UE capabilities, or different service types using preconfigured uplink resources (e.g., PRACH resource, physical uplink shared channel (PUSCH) resources, msgA resources, physical uplink control channel (PUCCH) resources), a quantity of uplink resources may be configured via the system information 205 (e.g., a stationary SIB) for a specific UE or service type (e.g., reduced capability, coverage enhancement, relaxed latency). Upon detecting a request 220 from the UE 115-a on these uplink resources (e.g., using energy detection), the network entity 105-a can transmit on-demand signaling 225 to the UE 115-a. The on-demand signaling 225 may include additional SSBs, SIBs, or reference signals to assist with random access procedures or other initial access procedures at the UE 115-a. The on-demand signaling 225 may be applicable to specific UE types, service types, or connection states (e.g., idle, inactive, or connected states). Multiple UEs or service types can share (e.g., access) the same uplink resources indicated by the system information 205 to trigger (e.g., request) transmission or activation of the on-demand signaling 225 in the same downlink BWP or in a separately configured downlink BWP.

After transmitting the request 220 on the uplink resources indicated by the system information 205 (e.g., a stationary SIB), the UE 115-a may receive a short message in a paging occasion (PO) dedicated to a specific UE or service type. Additionally or alternatively, the UE 115-a may receive a different multicast or broadcast message including a configuration or activation status of the on-demand signaling 225. Additional downlink and uplink resources can also be allocated for specific UE or service types via the on-demand signaling 225. The transmission and configuration of the on-demand signaling 225 may be consistent with capabilities, coverage levels, and other constraints associated with the specific UE or service type. In some examples, a radio resource mapping for the on-demand signaling 225 may be based on a synchronization raster, a channel raster, or repetition patterns configured for the UE or service type. Reception of the on-demand signaling 225 may trigger BWP switching or carrier switching at the UE 115-a. In some examples, capabilities of the UE 115-a or signaling from the network entity 105-a may determine whether other UE or service types can receive the on-demand signaling 225 (or additional on-demand downlink or uplink resources).

The wireless communications system 200 may support more efficient utilization of communication resources during initial access procedures between the UE 115-a and the network entity 105-a. More specifically, the techniques and operations described with reference to FIG. 2 may enable the network entity 105-a to provide the UE 115-a with a set of dynamically configured RACH resources, which the UE 115-a may use for transmission (or retransmission) of random access messages 210. Dynamically allocating RACH resources to the UE 115-a may enable the UE 115-a to perform initial access procedures with fewer collisions, reduced latency, and improved communication reliability, among other benefits. Moreover, the techniques described herein may enable the UE 115-a to activate (e.g., trigger) and receive on-demand signaling 225 from the network entity 105-a during initial access, which may improve the likelihood of successful communications between the UE 115-a and the network entity 105-a.

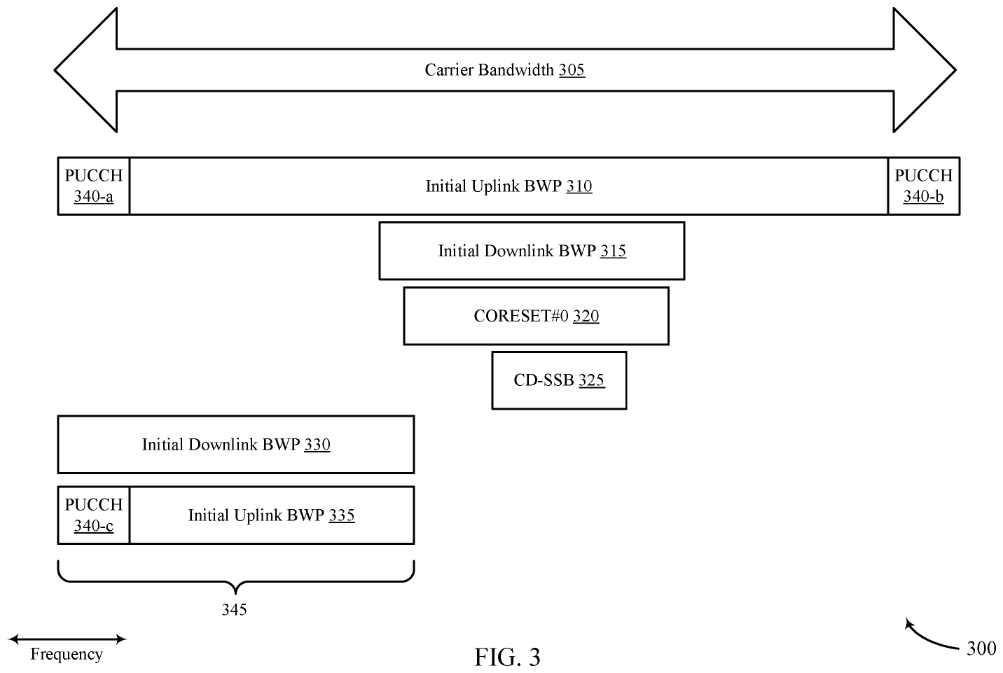

FIG. 3 illustrates an example of a resource diagram 300 that supports techniques for dynamic resource allocation in accordance with one or more aspects of the present disclosure. The resource diagram 300 may implement or be implemented by aspects of the wireless communications system 100 or the wireless communications system 200. For example, the resource diagram 300 may include a carrier bandwidth 305, an initial uplink BWP 310, and an initial downlink BWP 315, which may be configured by a network entity 105 described with reference to FIGS. 1 and 2. Similarly, the resource diagram 300 may include an initial downlink BWP 330 and an initial uplink BWP 335, which may be configured for a UE 115 described with reference to FIGS. 1 and 2. In the resource diagram 300, UEs with reduced capabilities (e.g., RedCap UEs) may be configured with an initial downlink BWP 330 and an initial uplink BWP 335, while other UEs may be configured with an initial uplink BWP 310 and an initial downlink BWP 315.

A UE (e.g., a non-RedCap UE) may be configured with a carrier bandwidth 305 and an initial uplink BWP 310 in a specific frequency range such as frequency range 1 (FR1). The carrier bandwidth 305 and the initial uplink BWP 310 may, in some examples, occupy a bandwidth greater than 100 MHz. The initial uplink BWP 310 may include PUCCH resources 340-a and PUCCH resources 340-b, which may be located at opposite ends of the initial uplink BWP 310. The UE may use the PUCCH resources 340 for transmission of HARQ acknowledgement (ACK) information during initial access procedures. The PUCCH resources 340 may be associated with relatively higher reliability (e.g., in comparison to other portions of the initial uplink BWP 310), which may improve the likelihood of a network entity successfully receiving the HARQ-ACK information.

The UE may also be configured with an initial downlink BWP 315, which may be indicated via SIB1. The UE may receive random access messages (e.g., RARs) from a network entity within the initial downlink BWP 315, which may enable the UE to establish an RRC connection with the network entity. In comparison to the initial uplink BWP 310, the initial downlink BWP 315 may occupy a relatively smaller frequency range, which may reduce the power consumption associated with downlink monitoring operations at the UE. Prior to initiating an RRC connection with the network entity (e.g., while in an idle or inactive state), the UE may scan a preconfigured synchronization raster and monitor for a cell-defined SSB (CD-SSB) 325. The CD-SSB 325 may include a primary synchronization signal (PSS), a secondary synchronization signal (SSS), and a physical broadcast channel (PBCH) transmission, which may enable the UE to acquire synchronization with the network entity. The CD-SSB 325 may also include a master information block (MIB) that indicates a configuration (e.g., resource mapping) for CORESET #0 320.

Accordingly, the UE may monitor the CORESET #0 320 for a PDCCH transmission, which may schedule transmission of SIB1. After receiving SIB1 and remaining minimum system information (RMSI), the UE may decode SIB1 and determine a configuration (e.g., resource mapping) for the initial uplink BWP 310, the initial downlink BWP 315, or both. The initial downlink BWP 315 may be configured to encompass both the CORESET #0 320 and the CD-SSB 325. The UE may use the initial uplink BWP 310 and the initial downlink BWP 315 after establishing an RRC connection with the network entity. In some cases, however, the initial uplink BWP 310 may not be suitable for RedCap UEs. Instead, these UEs may be configured with an initial downlink BWP 330 and an initial uplink BWP 335, which may occupy a bandwidth 345 of less than 20 MHz in FR1. The initial uplink BWP 335 may include PUCCH resources 340-c, which may overlap (e.g., in frequency) with the PUCCH resources 340-a.

The resource diagram 300 may support more efficient utilization of communication resources during initial access procedures between a UE and a network entity. More specifically, the techniques and operations described with reference to FIG. 3 may enable a network entity to provide a UE with a set of dynamically configured RACH resources, which the UE may use for transmission (or retransmission) of random access messages. Dynamically allocating RACH resources to the UE may enable the UE to perform initial access procedures with fewer collisions, reduced latency, and improved communication reliability, among other benefits. Moreover, the techniques described herein may enable a UE to activate (e.g., trigger) and receive on-demand signaling from a network entity during initial access, which may improve the likelihood of successful communications between the UE and the network entity.

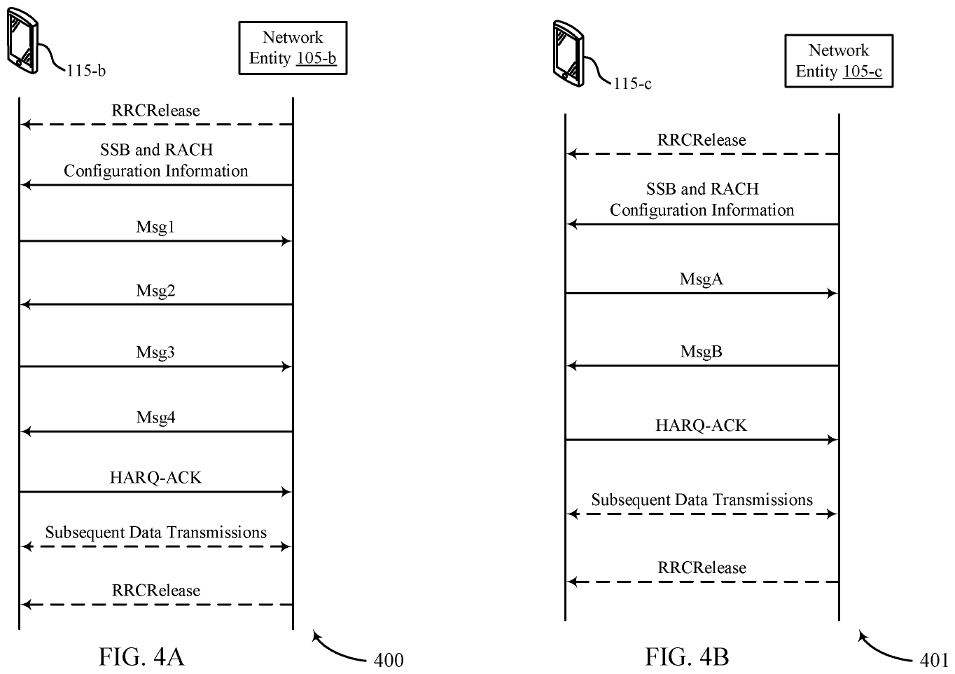

FIGS. 4A and 4B illustrate examples of a process flow 400 and a process flow 401 that support techniques for dynamic resource allocation in accordance with one or more aspects of the present disclosure. The process flow 400 and the process flow 401 may implement or be implemented by aspects of the wireless communications system 100 or the wireless communications system 200. For example, the process flow 400 may include a UE 115-b and a network entity 105-b, which may be examples of corresponding devices described with reference to FIGS. 1 and 2. Similarly, the process flow 401 may include a UE 115-c and a network entity 105-c, which may also be examples of corresponding devices described herein. In the following descriptions of the process flow 400 and the process flow 401, operations between the UEs 115 and the network entities 105 may be performed in a different order or at a different time than as shown. Additionally or alternatively, some operations may be omitted from the process flow 400 or the process flow 401, and other operations may be added to the process flow 400 or the process flow 401.

Both 2-step and 4-step RACH procedures can be used for RACH-based small data transmissions (SDT) in an inactive state (e.g., RRC_INACTIVE). To perform a RACH-based SDT, the UEs 115 may re-establish at least an SDT PDCP connection and use resource blocks (RBs) configured for SDTs. In subsequent data transmissions (e.g., after successful contention resolution), the UEs 115 may monitor a separate common search space (CSS), if configured, for one or more dynamic grants (DG) using a cell radio network temporary identifier (C-RNTI) in accordance with a RACH-based SDT scheme. An RRCRelease message may be used to terminate the SDT procedure (e.g., with respect to RRC). A MAC sub-header of a msg2 (in a 4-step RACH procedure) or a msgB (in a 2-step RACH procedure) may include a PRACH preamble index, such as a RAPID, which can be detected by the network entities 105. A RAR grant in the msg2 or the msgB may indicate or more timing advance (TA) commands, one or more uplink grants, one or more C-RNTIs, or a combination thereof.

The process flow 400 may illustrate a 4-step RACH procedure between the UE 115-b and the network entity 105-b. In some examples, the UE 115-b may perform the 4-step RACH procedure after receiving an RRCRelease message from the network entity 105-b. Prior to performing the 4-step RACH procedure, the UE 115-b may receive an SSB and RACH configuration information from the network entity 105-b. The SSB may include a PBCH transmission, a PSS, and an SSS, which the UE 115-b may use to acquire synchronization with the network entity 105-b. The RACH configuration information may indicate one or more RACH resources that the UE 115-b can use for transmission of msg1. To initiate the 4-step RACH procedure, the UE 115-b may transmit a msg1 on the RACH resources indicated by the RACH configuration information. The msg1 may include a random access preamble associated with a RAPID. Accordingly, the network entity 105-b may transmit a msg2 (e.g., a RAR) in response to the msg1.

Upon receiving the msg2, the UE 115-b may transmit a msg3, which may include an RRCResumeRequest, uplink data, a buffer status report (BSR) MAC control element (CE), or a combination thereof. The network entity 105-b may respond to the msg3 with a msg4 (e.g., a network response), which may include a contention resolution message. After successfully receiving the msg4, the UE 115-b may transmit HARQ-ACK information to confirm that contention resolution is successful. In some examples, the UE 115-b and the network entity 105-b may perform one or more subsequent data transmissions following contention resolution. For example, the UE 115-b may transmit uplink data to the network entity 105-b, and the network entity 105-b may transmit downlink data in response to the uplink data. The network entity 105-b may, in some examples, transmit an RRCRelease message to the UE 115-b upon completion of these subsequent data transmissions.

The process flow 401 may illustrate a 2-step RACH procedure between the UE 115-c and the network entity 105-c. In some examples, the UE 115-c may perform the 2-step RACH procedure after receiving an RRCRelease message from the network entity 105-c. Prior to performing the 2-step RACH procedure, the UE 115-c may receive an SSB and RACH configuration information from the network entity 105-c. The SSB may include a PBCH transmission, a PSS, and an SSS, which the UE 115-c may use to acquire synchronization with the network entity 105-c. The RACH configuration information may indicate one or more RACH resources that the UE 115-c can use for transmission of msgA. To initiate the 2-step RACH procedure, the UE 115-c may transmit a msgA on the RACH resources indicated by the RACH configuration information. The msgA may include a random access preamble and a PUSCH payload that includes an RRCResumeRequest, uplink data, a BSR MAC-CE, or a combination thereof.

Upon receiving the msgA, the network entity 105-c may transmit a msgB (e.g., a network response) that includes a contention resolution message. In some examples, the msgB may not include an RRC message. In response to the msgB, the UE 115-c may transmit HARQ-ACK information to the network entity 105-c to confirm that contention resolution is successful. In some examples, the UE 115-c and the network entity 105-c may perform one or more subsequent data transmissions following contention resolution. For example, the UE 115-c may transmit uplink data to the network entity 105-c, and the network entity 105-c may transmit downlink data in response to the uplink data. The network entity 105-c may, in some examples, transmit an RRCRelease message to the UE 115-c upon completion of these subsequent data transmissions.

The process flow 400 and the process flow 401 may support more efficient utilization of communication resources during initial access procedures between the UEs 115 and the network entities 105. More specifically, the techniques and operations described with reference to FIGS. 4A and 4B may enable the network entities 105 to provide the UEs 115 with a set of dynamically configured RACH resources, which the UEs 115 may use for transmission (or retransmission) of random access messages. Dynamically allocating RACH resources to the UEs 115 may enable the UEs 115 to perform initial access procedures with fewer collisions, reduced latency, and improved communication reliability, among other benefits. Moreover, the techniques described herein may enable the UEs 115 to activate (e.g., trigger) and receive on-demand signaling from the network entities 105 during initial access, which may improve the likelihood of successful communications between the UEs 115 and the network entities 105.

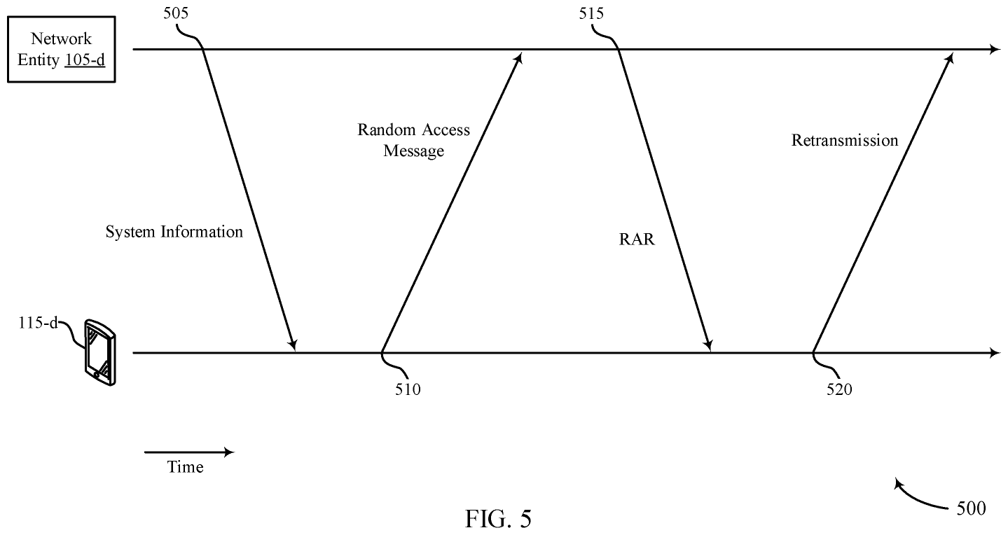

FIG. 5 illustrates an example of a process flow 500 that supports techniques for dynamic resource allocation in accordance with one or more aspects of the present disclosure. The process flow 500 may implement or be implemented by aspects of the wireless communications system 100, the wireless communications system 200, the process flow 400, or the process flow 401. For example, the process flow 500 may include a UE 115-d and a network entity 105-d, which may be examples of corresponding devices described herein. In the following description of the process flow 500, operations between the UE 115-d and the network entity 105-d may be performed in a different order or at a different time than as shown. Additionally or alternatively, some operations may be omitted from the process flow 500, and other operations may be added to the process flow 500.

In some cases, the UE 115-d may receive system information (e.g., a SIB) from the network entity 105-d, and may transmit an initial uplink transmission using RACH resources indicated by the system information. Upon receiving this initial uplink transmission, the network entity 105-d may transmit a response to the UE 115-d. If, for example, the UE 115-d is unable to decode the response prior to expiration of a preconfigured timer (e.g., due to fading or link budget constraints), the UE 115-d may re-attempt the uplink transmission after expiration of the preconfigured timer by selecting the same or different RACH resources indicated by the system information. The UE 115-d may re-attempt the uplink transmission with or without power ramping (e.g., using the same or different transmission powers). In some cases, however, re-attempting the uplink transmission on the same RACH resources may result in additional collisions and latency. The techniques and operations described with reference to FIG. 5 may enable the UE 115-d to re-attempt the uplink transmission using different (e.g., dynamically allocated) RACH resources, which may increase the likelihood of the network entity 105-d successfully receiving the uplink transmission.

At 505, the UE 115-d may receive system information (e.g., a SIB) indicating a first set of RACH resources allocated for transmission of random access messages. At 510, the UE 115-d may transmit a random access message (e.g., msg1, msgA) using the first set of RACH resources indicated by the system information. At 515, the network entity 105-d may transmit a RAR indicating a set of dynamically configured RACH resources from a RACH resource pool. If, for example, the UE 115-d decodes the RAR and is unable to identify a matching signature (e.g., a RAPID, a PRACH preamble, a UE identifier, a RNTI associated with a RACH resource) corresponding to the previous random access message, the UE 115-d may obtain additional resources from the dynamically configured RACH resource pool. In some examples, the RACH resource pool may be indicated by the RAR, a subsequent multicast or broadcast message scheduled by the RAR, or another channel that is scrambled using a group RNTI and scheduled by a group common DCI.

At 520, the UE 115-d may transmit a retransmission of the random access message using RACH resources from the dynamically configured RACH resource pool. More specifically, the UE 115-d may select one or more RACH resources from the RACH resource pool, and may retransmit the random access message on the selected RACH resources. In some examples, the dynamically configured RACH resource pool may be different from the RACH resources configured by the system information (e.g., different than indicated in SIB1). In other examples, the dynamically configured RACH resources may be multiplexed (e.g., in time, frequency, or space) with SIB-configured RACH resources. As described herein, these SIB-configured resources (also referred to as stationary RACH resources) may have a periodic availability and a constant mapping with respect to a time domain, a frequency domain, a code domain, a space domain, or a combination thereof. SIB-configured RACH resources may also be incompatible with some UE types and procedures that involve RACH resources. Moreover, SIB-configured RACH resource may have fixed resource allocations and partitions. In some cases, the network entity 105-d may not signal which SIB-configured RACH resources are available, which may result in congestion and signal collisions.

In contrast, dynamic RACH resources from the RACH resource pool may be available for a specific time duration, and may be allocated via multicast or broadcast channels (including RAR). These dynamic RACH resources may have an aperiodic availability or a periodic availability within a specific time duration (which may be provided to the UE 115-d and the network entity 105-d). The network entity 105-d may, in some examples, transmit an indication of which dynamic RACH resources are available, which may enable the UE 115-d to more effectively utilize the dynamic RACH resources. The dynamic RACH resources may support adaptive resource allocations and partitions. In contrast to SIB-configured RACH resources, these dynamic RACH resources may be flexible and time-varying.

The dynamic RACH resources may or may not overlap with SIB-configured RACH resources. Dynamic RACH resources may also be forward compatible with different UE types and procedures that involve RACH resources. In some examples, a size of the RACH resource pool may vary with respect to the time domain. The RACH resource pool may, in some examples, include SIB-configured RACH resources and dynamic RACH resources (e.g., RACH resources that are dynamically configured by a multicast or broadcast message, which may include a response to a PRACH transmission from the UE 115-d during an initial access procedure or a RACH-based procedure).

The process flow 500 may support more efficient utilization of communication resources during initial access procedures between the UE 115-d and the network entity 105-d. More specifically, the techniques and operations described with reference to FIG. 5 may enable the network entity 105-d to provide the UE 115-d with a set of dynamically configured RACH resources, which the UE 115-d may use for transmission (or retransmission) of random access messages. Dynamically allocating RACH resources to the UE 115-d may enable the UE 115-d to perform initial access procedures with fewer collisions, reduced latency, and improved communication reliability, among other benefits. Moreover, the techniques described herein may enable the UE 115-d to activate (e.g., trigger) and receive on-demand signaling from the network entity 105-d during initial access, which may improve the likelihood of successful communications between the UE 115-d and the network entity 105-d.

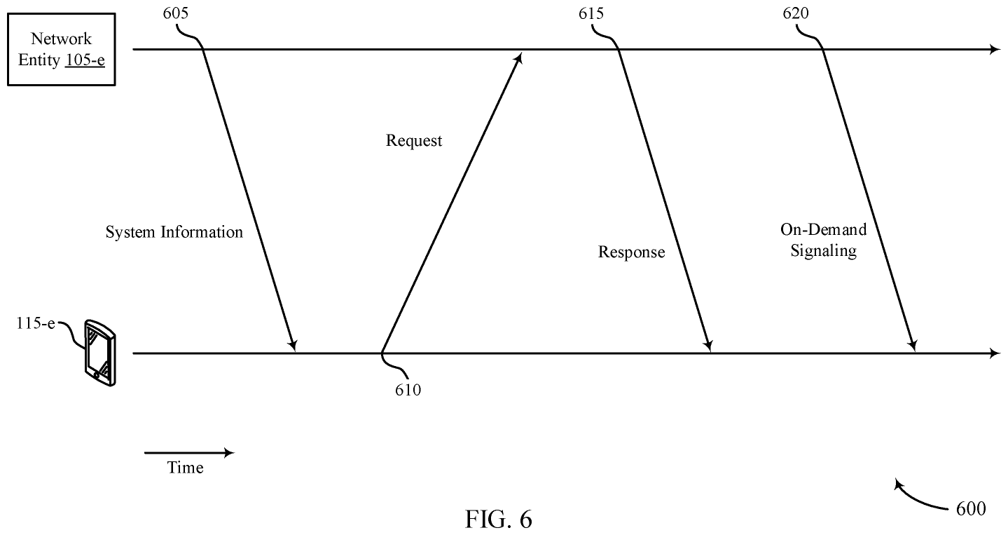

FIG. 6 illustrates an example of a process flow 600 that supports techniques for dynamic resource allocation in accordance with one or more aspects of the present disclosure. The process flow 600 may implement or be implemented by aspects of the wireless communications system 100, the wireless communications system 200, the process flow 400, the process flow 401, or the process flow 500. For example, the process flow 600 may include a UE 115-e and a network entity 105-e, which may be examples of corresponding devices described with reference to FIGS. 1 through 5. In the following description of the process flow 600, operations between the UE 115-e and the network entity 105-e may be performed in a different order or at a different time than as shown. Additionally or alternatively, some operations may be omitted from the process flow 600, and other operations may be added to the process flow 600.

At 605, the network entity 105-e may transmit system information (e.g., a stationary SIB) indicating a first set of resources for requesting on-demand signaling (also referred to herein as activated signaling), a second set of resources allocated for transmission of on-demand signaling, or both. The system information may also include an SSB (e.g., a PSS, an SSS, and a PBCH transmission) and RACH configuration information, which may enable the UE 115-e to initiate a RACH procedure with the network entity 105-e. The network entity 105-e may transmit the system information in a first downlink BWP. The first set of resources may, in some examples, include preconfigured or dedicated uplink resources that pertain to a capability of the UE 115-e, a link quality of the UE 115-e, a service type, a contention resolution status of the UE 115-e, or a coverage level. The preconfigured uplink resources may be located within a first uplink BWP.

At 610, the UE 115-e may trigger (e.g., activate) transmission of the on-demand signaling in the first downlink BWP or in a second downlink BWP that is different from the first downlink BWP. The UE 115-e may activate transmission of the on-demand signaling using the preconfigured uplink resources in the first uplink BWP (e.g., the resources indicated by the system information). For example, the UE 115-e may transmit a random access message (e.g., msg1, msgA) indicating a request for the on-demand signaling. The UE 115-e may also use the preconfigured resources to request an on-demand downlink or uplink resource allocation, which may be specific to a capability or service type of the UE 115-e. In some examples, the UE 115-e may request uplink or downlink resources in a specific BWP or carrier.

At 615, the network entity 105-e may respond to the request from the UE 115-e. For example, the network entity 105-e may transmit a paging message or a RAR indicating the second set of resources allocated for transmission of the on-demand resources, an activation status of the second set of resources, an availability of the second set of resources, or a combination thereof. The RAR may also indicate a radio resource mapping between the second set of resources and the on-demand signaling. This radio resource mapping may include a synchronization raster, a channel raster, or a repetition pattern configured for the on-demand signaling. The second set of resources may be located in the first downlink BWP or the second downlink BWP. Accordingly, the network entity 105-e may transmit the on-demand signaling via the second set of resources. The on-demand signaling may include a SIB, an SSB, a set of reference signals, a PBCH transmission, timing information associated with the on-demand signaling, or a combination thereof.

At 620, the UE 115-e may receive the on-demand signaling in the first downlink BWP or in the second downlink BWP. In some examples, the UE 115-e may monitor for and receive the on-demand signaling in accordance with the indicated radio resource mapping. The on-demand signaling may be specific to a capability of the UE 115-e, a service type of the UE 115-e, a coverage level of the UE 115-e, a link quality of the UE 115-e, a contention resolution status of the UE 115-e, or a combination thereof. In some examples, the on-demand signaling may configure additional uplink resources, downlink resources, or measurement objects for the UE 115-e. These downlink resources, uplink resources, or measurement objects may be located in the first downlink BWP, the second downlink BWP, the first uplink BWP, or the second uplink BWP. In some examples, the on-demand signaling may configure the UE 115-e to perform one or more of a BWP switching procedure, a carrier switching procedure, a beam switching procedure, an antenna switching procedure, a random backoff procedure, a frequency hopping procedure, or a coverage enhancement procedure.

The process flow 600 may support more efficient utilization of communication resources during initial access procedures between the UE 115-e and the network entity 105-e. More specifically, the techniques and operations described with reference to FIG. 6 may enable the network entity 105-e to provide the UE 115-e with a set of dynamically configured RACH resources, which the UE 115-e may use for transmission (or retransmission) of random access messages. Dynamically allocating RACH resources to the UE 115-e may enable the UE 115-e to perform initial access procedures with fewer collisions, reduced latency, and improved communication reliability, among other benefits. Moreover, the techniques described herein may enable the UE 115-e to activate (e.g., trigger) and receive on-demand signaling from the network entity 105-e during initial access, which may improve the likelihood of successful communications between the UE 115-e and the network entity 105-e.

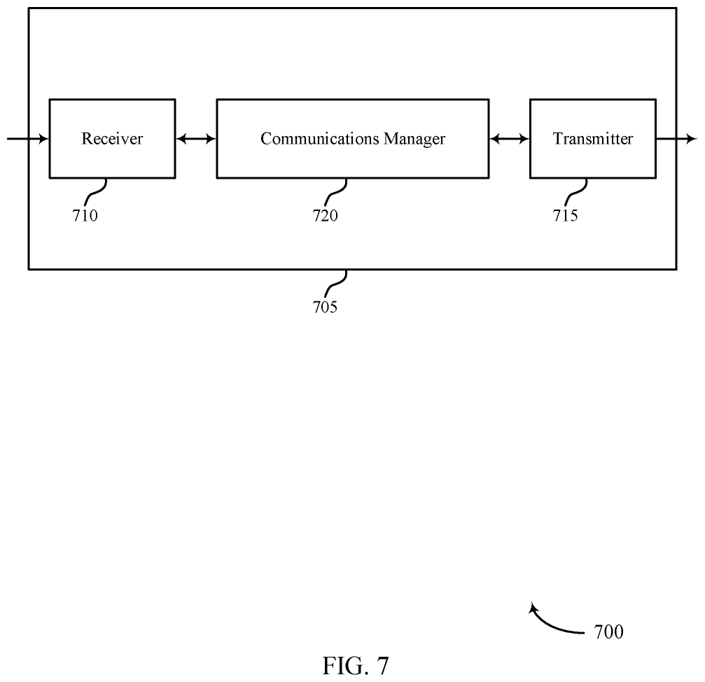

FIG. 7 shows a block diagram 700 of a device 705 that supports techniques for dynamic resource allocation in accordance with one or more aspects of the present disclosure. The device 705 may be an example of aspects of a UE 115 as described herein. The device 705 may include a receiver 710, a transmitter 715, and a communications manager 720. The device 705 may also include at least one processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for dynamic resource allocation). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for dynamic resource allocation). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of techniques for dynamic resource allocation as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include at least one processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, at least one processor and memory coupled with (e.g., operatively, communicatively, functionally, electronically, or electrically) the at least one processor may be configured to perform one or more of the functions described herein (e.g., by executing, by the at least one processor, instructions stored in the memory).

Additionally, or alternatively, in some examples, the communications manager 720, the receiver 710, the transmitter 715, or various combinations or components thereof may be implemented in code (e.g., as communications management software) executed by at least one processor. If implemented in code executed by at least one processor, the functions of the communications manager 720, the receiver 710, the transmitter 715, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE (e.g., the device 705) in accordance with examples as disclosed herein. For example, the communications manager 720 may be configured as or otherwise support a means for receiving, in a first downlink BWP, system information indicating a first set of resources allocated for transmission of random access messages in a first uplink BWP. The communications manager 720 may be configured as or otherwise support a means for transmitting a random access message via the first set of resources in accordance with the system information. The communications manager 720 may be configured as or otherwise support a means for receiving a RAR indicating a second set of resources that are different from the first set of resources. The communications manager 720 may be configured as or otherwise support a means for transmitting a retransmission of the random access message via the second set of resources in accordance with the RAR.

Additionally, or alternatively, the communications manager 720 may support wireless communications at a UE (e.g., the device 705) in accordance with examples as disclosed herein. For example, the communications manager 720 may be configured as or otherwise support a means for receiving, in a first downlink BWP, system information indicating a first set of resources for requesting on-demand signaling. The communications manager 720 may be configured as or otherwise support a means for transmitting, in a first uplink BWP and via the first set of resources, a request for the on-demand signaling. The communications manager 720 may be configured as or otherwise support a means for receiving an indication of a second set of resources allocated for reception of the on-demand signaling. The communications manager 720 may be configured as or otherwise support a means for monitoring the second set of resources for the on-demand signaling in accordance with the indication.

By including or configuring the communications manager 720 in accordance with examples as described herein, the device 705 (e.g., at least one processor controlling or otherwise coupled (e.g., operatively, communicatively, functionally, electronically, or electrically) with the receiver 710, the transmitter 715, the communications manager 720, or a combination thereof) may support techniques for reduced power consumption and more efficient utilization of communication resources during initial access procedures between the device 705 and other network entities. More specifically, the techniques and operations described herein may enable a network entity to provide the device 705 with a set of dynamically configured RACH resources, which the device 705 may use for transmission (or retransmission) of random access messages. Dynamically allocating RACH resources to the device 705 may enable the device 705 to perform initial access procedures with fewer collisions, reduced latency, and improved communication reliability, among other benefits. Moreover, the techniques described herein may enable the device 705 to activate (e.g., trigger) and receive on-demand signaling from the network entity during initial access, which may improve the likelihood of successful communications between the device 705 and the network entity.

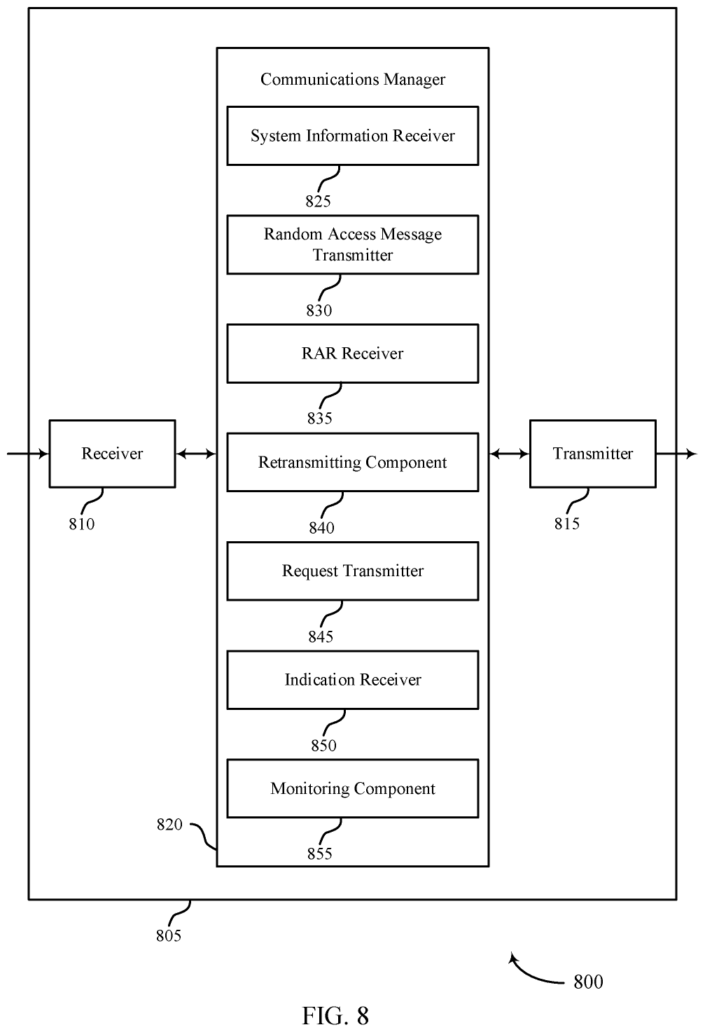

FIG. 8 shows a block diagram 800 of a device 805 that supports techniques for dynamic resource allocation in accordance with one or more aspects of the present disclosure. The device 805 may be an example of aspects of a device 705 or a UE 115 as described herein. The device 805 may include a receiver 810, a transmitter 815, and a communications manager 820. The device 805 may also include at least one processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for dynamic resource allocation). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for dynamic resource allocation). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for dynamic resource allocation as described herein. For example, the communications manager 820 may include a system information receiver 825, a random access message transmitter 830, a RAR receiver 835, a retransmitting component 840, a request transmitter 845, an indication receiver 850, a monitoring component 855, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a UE (e.g., the device 805) in accordance with examples as disclosed herein. The system information receiver 825 may be configured as or otherwise support a means for receiving, in a first downlink BWP, system information indicating a first set of resources allocated for transmission of random access messages in a first uplink BWP. The random access message transmitter 830 may be configured as or otherwise support a means for transmitting a random access message via the first set of resources in accordance with the system information. The RAR receiver 835 may be configured as or otherwise support a means for receiving a RAR indicating a second set of resources that are different from the first set of resources. The retransmitting component 840 may be configured as or otherwise support a means for transmitting a retransmission of the random access message via the second set of resources in accordance with the RAR.

Additionally, or alternatively, the communications manager 820 may support wireless communications at a UE (e.g., the device 805) in accordance with examples as disclosed herein. The system information receiver 825 may be configured as or otherwise support a means for receiving, in a first downlink BWP, system information indicating a first set of resources for requesting on-demand signaling. The request transmitter 845 may be configured as or otherwise support a means for transmitting, in a first uplink BWP and via the first set of resources, a request for the on-demand signaling. The indication receiver 850 may be configured as or otherwise support a means for receiving an indication of a second set of resources allocated for reception of the on-demand signaling. The monitoring component 855 may be configured as or otherwise support a means for monitoring the second set of resources for the on-demand signaling in accordance with the indication.

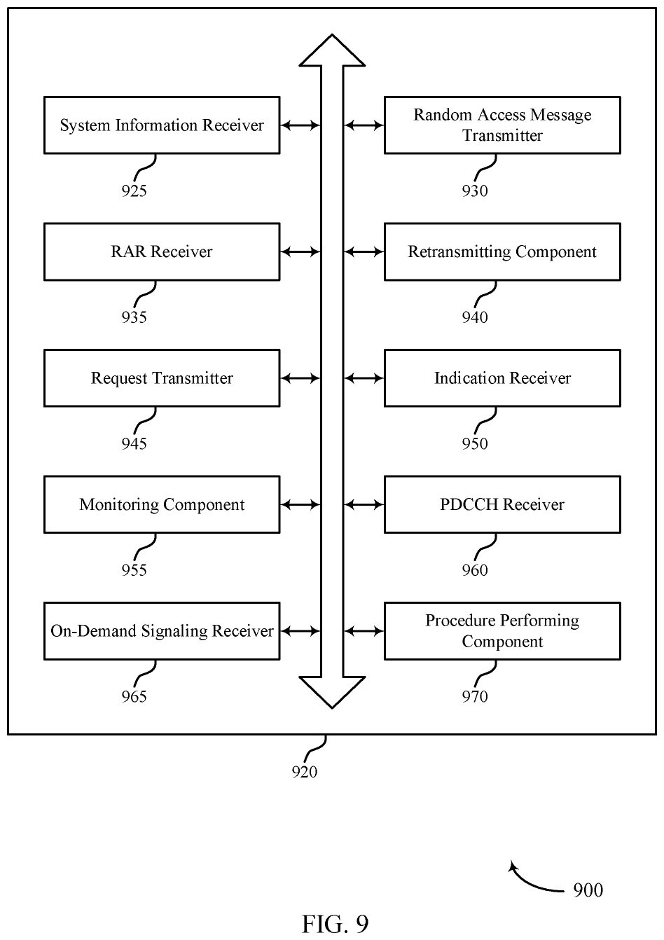

FIG. 9 shows a block diagram 900 of a communications manager 920 that supports techniques for dynamic resource allocation in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for dynamic resource allocation as described herein. For example, the communications manager 920 may include a system information receiver 925, a random access message transmitter 930, a RAR receiver 935, a retransmitting component 940, a request transmitter 945, an indication receiver 950, a monitoring component 955, a PDCCH receiver 960, an on-demand signaling receiver 965, a procedure performing component 970, or any combination thereof. Each of these components may communicate, directly or indirectly, with one another (e.g., via one or more buses).

The communications manager 920 may support wireless communications at a UE in accordance with examples as disclosed herein. The system information receiver 925 may be configured as or otherwise support a means for receiving, in a first downlink BWP, system information indicating a first set of resources allocated for transmission of random access messages in a first uplink BWP. The random access message transmitter 930 may be configured as or otherwise support a means for transmitting a random access message via the first set of resources in accordance with the system information. The RAR receiver 935 may be configured as or otherwise support a means for receiving a RAR indicating a second set of resources that are different from the first set of resources. The retransmitting component 940 may be configured as or otherwise support a means for transmitting a retransmission of the random access message via the second set of resources in accordance with the RAR.

In some examples, to support receiving the RAR, the RAR receiver 935 may be configured as or otherwise support a means for receiving the RAR indicating the second set of resources and a time duration in which the second set of resources are available for retransmission of random access messages. In some examples, to support receiving the RAR, the RAR receiver 935 may be configured as or otherwise support a means for receiving the RAR indicating the second set of resources that are multiplexed with the first set of resources in a time domain, a frequency domain, a space domain, or a combination thereof. In some examples, to support receiving the RAR, the RAR receiver 935 may be configured as or otherwise support a means for receiving the RAR indicating the second set of resources in the first uplink BWP or in a second uplink BWP that is different from the first uplink BWP.

In some examples, to support receiving the RAR, the RAR receiver 935 may be configured as or otherwise support a means for receiving the RAR indicating the second set of resources and a random access signature that includes one or more of a RAPID, a UE identifier, or a temporary identifier associated with a random access resource, where transmitting the retransmission of the random access message is based on comparing the random access signature from the RAR to a random access signature associated with the random access message.

In some examples, to support receiving the RAR, the RAR receiver 935 may be configured as or otherwise support a means for receiving the RAR indicating a random access resource pool that includes the second set of resources, where transmitting the retransmission of the random access message via the second set of resources is based on selecting the second set of resources from the random access resource pool.

In some examples, the PDCCH receiver 960 may be configured as or otherwise support a means for receiving a multicast or broadcast downlink control channel transmission indicating one or more resources allocated for reception of the RAR, where the multicast or broadcast downlink control channel transmission includes group-common downlink control information. In some examples, the monitoring component 955 may be configured as or otherwise support a means for monitoring the one or more resources for the RAR in accordance with the multicast or broadcast downlink control channel transmission, where the RAR is scrambled using a group identifier.

In some examples, to support transmitting the retransmission of the random access message, the retransmitting component 940 may be configured as or otherwise support a means for transmitting the retransmission of the random access message via the second set of resources in accordance with a power ramping scheme, a beam switching scheme, an antenna switching scheme, a BWP switching scheme, a carrier switching scheme, a random backoff scheme, a frequency hopping scheme, a coverage enhancement scheme, or a combination thereof.

Additionally, or alternatively, the communications manager 920 may support wireless communications at a UE in accordance with examples as disclosed herein. In some examples, the system information receiver 925 may be configured as or otherwise support a means for receiving, in a first downlink BWP, system information indicating a first set of resources for requesting on-demand signaling. The request transmitter 945 may be configured as or otherwise support a means for transmitting, in a first uplink BWP and via the first set of resources, a request for the on-demand signaling. The indication receiver 950 may be configured as or otherwise support a means for receiving an indication of a second set of resources allocated for reception of the on-demand signaling. The monitoring component 955 may be configured as or otherwise support a means for monitoring the second set of resources for the on-demand signaling in accordance with the indication.

In some examples, to support receiving the system information, the system information receiver 925 may be configured as or otherwise support a means for receiving, in the first downlink BWP, the system information that indicates one or both of the first set of resources or the second set of resources.

In some examples, to support receiving the indication of the second set of resources, the indication receiver 950 may be configured as or otherwise support a means for receiving a RAR indicating an activation status of the second set of resources, an availability of the second set of resources, or both.

In some examples, to support transmitting the request, the random access message transmitter 930 may be configured as or otherwise support a means for transmitting, via the first set of resources, a random access message including the request for the on-demand signaling.

In some examples, the on-demand signaling receiver 965 may be configured as or otherwise support a means for receiving, via the second set of resources, the on-demand signaling that includes a SIB, an SSB, a set of reference signals, a broadcast channel transmission, timing information associated with the on-demand signaling, or a combination thereof.

In some examples, the on-demand signaling receiver 965 may be configured as or otherwise support a means for receiving, via the second set of resources, the on-demand signaling that indicates a set of uplink resources, a set of downlink resources, a set of measurement objects, a set of random access resources allocated for retransmission of random access messages, or a combination thereof.

In some examples, the on-demand signaling indicates the set of random access resources, and the retransmitting component 940 may be configured as or otherwise support a means for transmitting a retransmission of a random access message via the set of random access resources indicated by the on-demand signaling.

In some examples, the on-demand signaling receiver 965 may be configured as or otherwise support a means for receiving a set of multiple repetitions of the on-demand signaling via the second set of resources.

In some examples, the on-demand signaling receiver 965 may be configured as or otherwise support a means for receiving the on-demand signaling in the first downlink BWP or in a second downlink BWP that is different from the first downlink BWP.

In some examples, to support receiving the indication of the second set of resources, the indication receiver 950 may be configured as or otherwise support a means for receiving the indication of a radio resource mapping between the second set of resources and the on-demand signaling, the radio resource mapping associated with a capability of the UE, a service type of the UE, a link quality of the UE, or a combination thereof. In some examples, the radio resource mapping indicates one or more of a synchronization raster, a channel raster, or a repetition pattern associated with the capability of the UE, the service type of the UE, the link quality of the UE, or a combination thereof.

In some examples, the procedure performing component 970 may be configured as or otherwise support a means for performing one or more of a BWP switching procedure, a carrier switching procedure, a beam switching procedure, an antenna switching procedure, a random backoff procedure, a frequency hopping procedure, or a coverage enhancement procedure based on receiving the on-demand signaling via the second set of resources.

In some examples, the indication receiver 950 may be configured as or otherwise support a means for receiving an indication that the on-demand signaling, the second set of resources, or both are specific to a capability of the UE, a service type of the UE, a coverage level of the UE, a link quality of the UE, a contention resolution status of the UE, or a combination thereof.

In some examples, to support receiving the system information, the system information receiver 925 may be configured as or otherwise support a means for receiving the system information indicating the first set of resources for requesting the on-demand signaling, the first set of resources including dedicated resources associated with a capability of the UE, a service type of the UE, a link quality of the UE, or a combination thereof.

In some examples, to support receiving the indication of the second set of resources, the indication receiver 950 may be configured as or otherwise support a means for receiving a paging message in a paging occasion associated with a capability of the UE, a service type of the UE, a link quality of the UE, or a combination thereof, where the paging message includes the indication of the second set of resources.

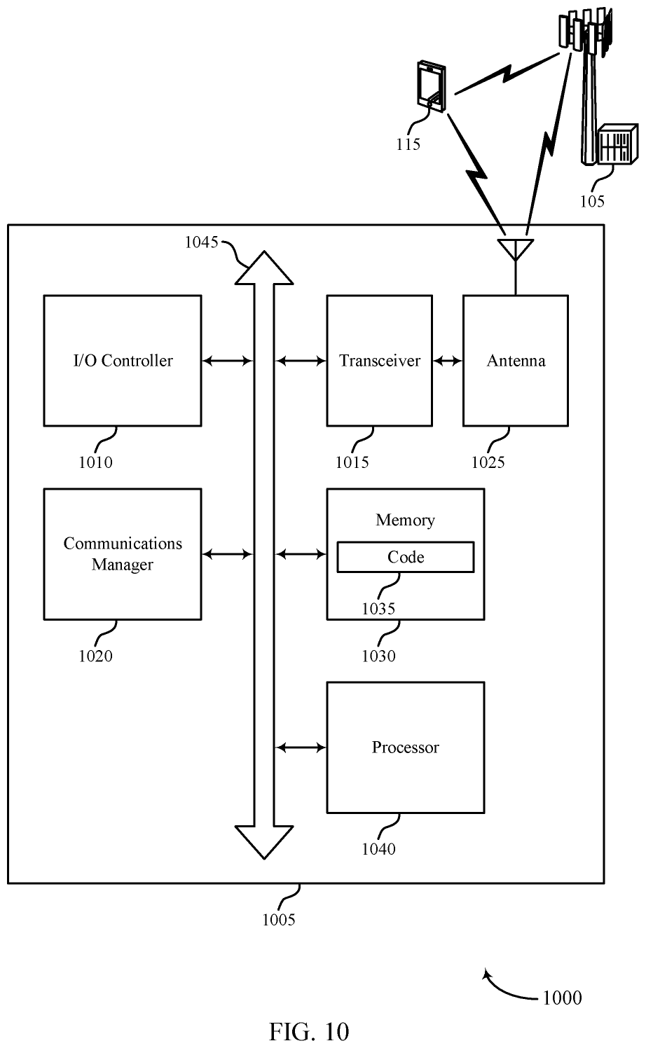

FIG. 10 shows a diagram of a system 1000 including a device 1005 that supports techniques for dynamic resource allocation in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOSR, ANDROIDR, MS-DOSR, MS-WINDOWS®, OS/2R, UNIX, LINUXR, or another known operating system. Additionally or alternatively, the I/O controller 1010 may represent or interact with a modem, a keyboard, a mouse, a touchscreen, or a similar device. In some cases, the I/O controller 1010 may be implemented as part of at least one processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting techniques for dynamic resource allocation). For example, the device 1005 or a component of the device 1005 may include a processor 1040 and memory 1030 coupled (e.g., operatively, communicatively, functionally, electronically, or electrically) with or to the processor 1040, the processor 1040 and memory 1030 configured to perform various functions described herein.

The communications manager 1020 may support wireless communications at a UE (e.g., the device 1005) in accordance with examples as disclosed herein. For example, the communications manager 1020 may be configured as or otherwise support a means for receiving, in a first downlink BWP, system information indicating a first set of resources allocated for transmission of random access messages in a first uplink BWP. The communications manager 1020 may be configured as or otherwise support a means for transmitting a random access message via the first set of resources in accordance with the system information. The communications manager 1020 may be configured as or otherwise support a means for receiving a RAR indicating a second set of resources that are different from the first set of resources. The communications manager 1020 may be configured as or otherwise support a means for transmitting a retransmission of the random access message via the second set of resources in accordance with the RAR.

Additionally, or alternatively, the communications manager 1020 may support wireless communications at a UE (e.g., the device 1005) in accordance with examples as disclosed herein. For example, the communications manager 1020 may be configured as or otherwise support a means for receiving, in a first downlink BWP, system information indicating a first set of resources for requesting on-demand signaling. The communications manager 1020 may be configured as or otherwise support a means for transmitting, in a first uplink BWP and via the first set of resources, a request for the on-demand signaling. The communications manager 1020 may be configured as or otherwise support a means for receiving an indication of a second set of resources allocated for reception of the on-demand signaling. The communications manager 1020 may be configured as or otherwise support a means for monitoring the second set of resources for the on-demand signaling in accordance with the indication.

By including or configuring the communications manager 1020 in accordance with examples as described herein, the device 1005 may support techniques for improved communication reliability, reduced latency, and improved user experience by retransmitting random access messages on dynamically configured RACH resources from a RACH resource pool. More specifically, the techniques and operations described herein may enable a network entity to provide the device 1005 with a set of dynamically configured RACH resources, which the device 1005 may use for transmission (or retransmission) of random access messages. Dynamically allocating RACH resources to the device 1005 may enable the device 1005 to perform initial access procedures with fewer collisions, reduced latency, and improved communication reliability, among other benefits. Moreover, the techniques described herein may enable the device 1005 to activate (e.g., trigger) and receive on-demand signaling from the network entity during initial access, which may improve the likelihood of successful communications between the device 1005 and the network entity.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of techniques for dynamic resource allocation as described herein, or the processor 1040 and the memory 1030 may be otherwise configured to perform or support such operations.

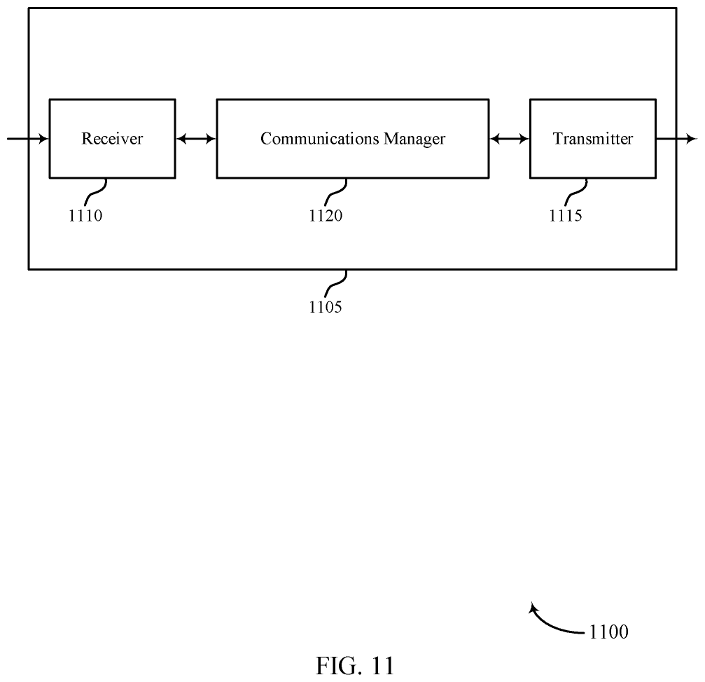

FIG. 11 shows a block diagram 1100 of a device 1105 that supports techniques for dynamic resource allocation in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include at least one processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled (e.g., operatively, communicatively, functionally, electronically, or electrically) with a modem.

The communications manager 1120, the receiver 1110, the transmitter 1115, or various combinations thereof or various components thereof may be examples of means for performing various aspects of techniques for dynamic resource allocation as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include at least one processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, at least one processor and memory coupled (e.g., operatively, communicatively, functionally, electronically, or electrically) with the at least one processor may be configured to perform one or more of the functions described herein (e.g., by executing, by the at least one processor, instructions stored in the memory).

Additionally, or alternatively, in some examples, the communications manager 1120, the receiver 1110, the transmitter 1115, or various combinations or components thereof may be implemented in code (e.g., as communications management software) executed by at least one processor. If implemented in code executed by at least one processor, the functions of the communications manager 1120, the receiver 1110, the transmitter 1115, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity (e.g., the device 1105) in accordance with examples as disclosed herein. For example, the communications manager 1120 may be configured as or otherwise support a means for transmitting, in a first downlink BWP, system information indicating a first set of resources allocated for reception of random access messages in a first uplink BWP. The communications manager 1120 may be configured as or otherwise support a means for monitoring the first set of resources for a random access message in accordance with the system information. The communications manager 1120 may be configured as or otherwise support a means for transmitting a RAR based on monitoring the first set of resources, the RAR indicating a second set of resources that are different from the first set of resources. The communications manager 1120 may be configured as or otherwise support a means for monitoring the second set of resources for a retransmission of the random access message in accordance with the RAR.

Additionally, or alternatively, the communications manager 1120 may support wireless communications at a network entity (e.g., the device 1105) in accordance with examples as disclosed herein. For example, the communications manager 1120 may be configured as or otherwise support a means for transmitting, in a first downlink BWP, system information indicating a first set of resources for requesting transmission of on-demand signaling. The communications manager 1120 may be configured as or otherwise support a means for receiving, in a first uplink BWP and via the first set of resources, a request for the on-demand signaling. The communications manager 1120 may be configured as or otherwise support a means for transmitting an indication of a second set of resources allocated for transmission of the on-demand signaling. The communications manager 1120 may be configured as or otherwise support a means for transmitting the on-demand signaling via the second set of resources in accordance with the indication.

By including or configuring the communications manager 1120 in accordance with examples as described herein, the device 1105 (e.g., at least one processor controlling or otherwise coupled (e.g., operatively, communicatively, functionally, electronically, or electrically) with the receiver 1110, the transmitter 1115, the communications manager 1120, or a combination thereof) may support techniques for reduced processing, reduced power consumption, and more efficient utilization of communication resources by configuring a UE to perform RACH retransmissions on dynamically allocated RACH resources from a RACH resource pool. More specifically, the techniques and operations described herein may enable the device 1105 to provide the UE with a set of dynamically configured RACH resources, which the UE may use for transmission (or retransmission) of random access messages. Dynamically allocating RACH resources to the UE may enable the UE to perform initial access procedures with fewer collisions, reduced latency, and improved communication reliability, among other benefits. Moreover, the techniques described herein may enable the UE to activate (e.g., trigger) and receive on-demand signaling from the device 1105 during initial access, which may improve the likelihood of successful communications between the UE and the device 1105.

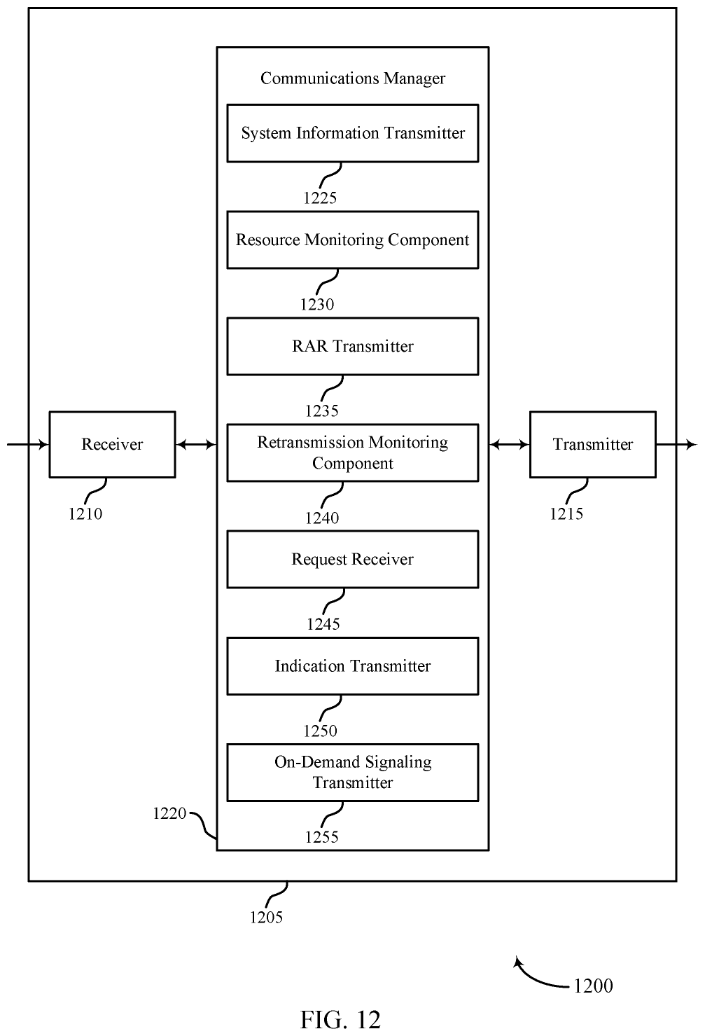

FIG. 12 shows a block diagram 1200 of a device 1205 that supports techniques for dynamic resource allocation in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include at least one processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled (e.g., operatively, communicatively, functionally, electronically, or electrically) with a modem.

The device 1205, or various components thereof, may be an example of means for performing various aspects of techniques for dynamic resource allocation as described herein. For example, the communications manager 1220 may include a system information transmitter 1225, a resource monitoring component 1230, a RAR transmitter 1235, a retransmission monitoring component 1240, a request receiver 1245, an indication transmitter 1250, an on-demand signaling transmitter 1255, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a network entity (e.g., the device 1205) in accordance with examples as disclosed herein. The system information transmitter 1225 may be configured as or otherwise support a means for transmitting, in a first downlink BWP, system information indicating a first set of resources allocated for reception of random access messages in a first uplink BWP. The resource monitoring component 1230 may be configured as or otherwise support a means for monitoring the first set of resources for a random access message in accordance with the system information. The RAR transmitter 1235 may be configured as or otherwise support a means for transmitting a RAR based on monitoring the first set of resources, the RAR indicating a second set of resources that are different from the first set of resources. The retransmission monitoring component 1240 may be configured as or otherwise support a means for monitoring the second set of resources for a retransmission of the random access message in accordance with the RAR.

Additionally, or alternatively, the communications manager 1220 may support wireless communications at a network entity (e.g., the device 1205) in accordance with examples as disclosed herein. The system information transmitter 1225 may be configured as or otherwise support a means for transmitting, in a first downlink BWP, system information indicating a first set of resources for requesting transmission of on-demand signaling. The request receiver 1245 may be configured as or otherwise support a means for receiving, in a first uplink BWP and via the first set of resources, a request for the on-demand signaling. The indication transmitter 1250 may be configured as or otherwise support a means for transmitting an indication of a second set of resources allocated for transmission of the on-demand signaling. The on-demand signaling transmitter 1255 may be configured as or otherwise support a means for transmitting the on-demand signaling via the second set of resources in accordance with the indication.

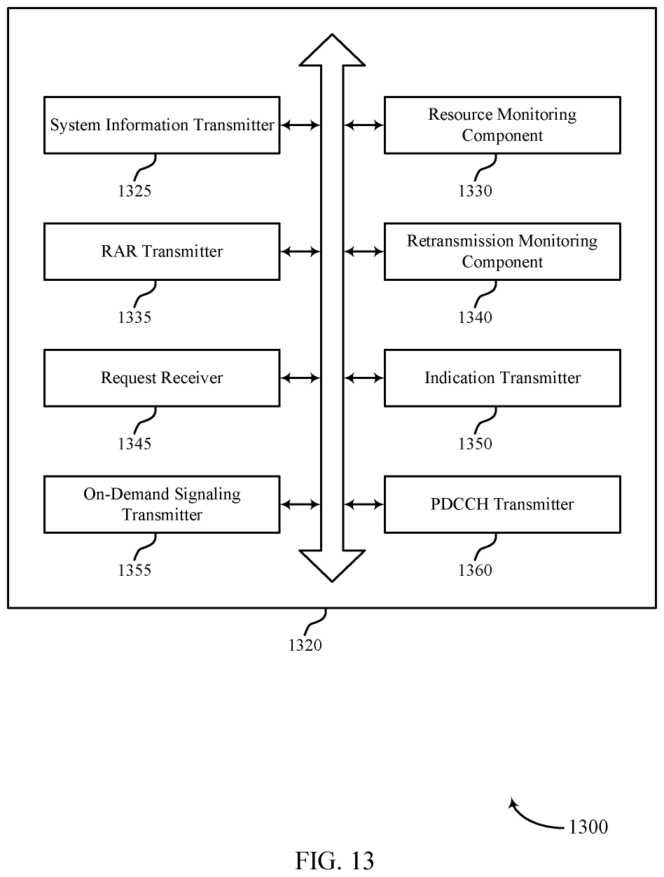

FIG. 13 shows a block diagram 1300 of a communications manager 1320 that supports techniques for dynamic resource allocation in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for dynamic resource allocation as described herein. For example, the communications manager 1320 may include a system information transmitter 1325, a resource monitoring component 1330, a RAR transmitter 1335, a retransmission monitoring component 1340, a request receiver 1345, an indication transmitter 1350, an on-demand signaling transmitter 1355, a PDCCH transmitter 1360, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications at a network entity in accordance with examples as disclosed herein. The system information transmitter 1325 may be configured as or otherwise support a means for transmitting, in a first downlink BWP, system information indicating a first set of resources allocated for reception of random access messages in a first uplink BWP. The resource monitoring component 1330 may be configured as or otherwise support a means for monitoring the first set of resources for a random access message in accordance with the system information. The RAR transmitter 1335 may be configured as or otherwise support a means for transmitting a RAR based on monitoring the first set of resources, the RAR indicating a second set of resources that are different from the first set of resources. The retransmission monitoring component 1340 may be configured as or otherwise support a means for monitoring the second set of resources for a retransmission of the random access message in accordance with the RAR.

In some examples, to support transmitting the RAR, the RAR transmitter 1335 may be configured as or otherwise support a means for transmitting the RAR indicating the second set of resources and a time duration in which the second set of resources are available for retransmission of random access messages.

In some examples, to support transmitting the RAR, the RAR transmitter 1335 may be configured as or otherwise support a means for transmitting the RAR indicating the second set of resources that are multiplexed with the first set of resources in a time domain, a frequency domain, a space domain, or a combination thereof. In some examples, to support transmitting the RAR, the RAR transmitter 1335 may be configured as or otherwise support a means for transmitting the RAR indicating the second set of resources in the first uplink BWP or in a second uplink BWP that is different from the first uplink BWP. In some examples, to support transmitting the RAR, the RAR transmitter 1335 may be configured as or otherwise support a means for transmitting the RAR indicating the second set of resources and a random access signature that includes one or more of a RAPID, a UE identifier, or a temporary identifier associated with a random access resource. In some examples, to support transmitting the RAR, the RAR transmitter 1335 may be configured as or otherwise support a means for transmitting the RAR indicating a random access resource pool that includes the second set of resources.

In some examples, the PDCCH transmitter 1360 may be configured as or otherwise support a means for transmitting a multicast or broadcast downlink control channel transmission indicating one or more resources allocated for transmission of the RAR, where the multicast or broadcast downlink control channel transmission includes group-common downlink control information. In some examples, the RAR transmitter 1335 may be configured as or otherwise support a means for transmitting the RAR via the one or more resources in accordance with the multicast or broadcast downlink control channel transmission, where the RAR is scrambled using a group identifier.

In some examples, the retransmission monitoring component 1340 may be configured as or otherwise support a means for receiving the retransmission of the random access message via the second set of resources in accordance with a power ramping scheme, a beam switching scheme, an antenna switching scheme, a BWP switching scheme, a carrier switching scheme, a random backoff scheme, a frequency hopping scheme, a coverage enhancement scheme, or a combination thereof.

Additionally, or alternatively, the communications manager 1320 may support wireless communications at a network entity in accordance with examples as disclosed herein. In some examples, the system information transmitter 1325 may be configured as or otherwise support a means for transmitting, in a first downlink BWP, system information indicating a first set of resources for requesting transmission of on-demand signaling. The request receiver 1345 may be configured as or otherwise support a means for receiving, in a first uplink BWP and via the first set of resources, a request for the on-demand signaling. The indication transmitter 1350 may be configured as or otherwise support a means for transmitting an indication of a second set of resources allocated for transmission of the on-demand signaling. The on-demand signaling transmitter 1355 may be configured as or otherwise support a means for transmitting the on-demand signaling via the second set of resources in accordance with the indication.

In some examples, to support transmitting the system information, the system information transmitter 1325 may be configured as or otherwise support a means for transmitting, in the first downlink BWP, the system information indicating one or both of the first set of resources or the second set of resources. In some examples, to support transmitting the indication of the second set of resources, the indication transmitter 1350 may be configured as or otherwise support a means for transmitting a RAR indicating an activation status of the second set of resources, an availability of the second set of resources, or both. In some examples, to support receiving the request, the request receiver 1345 may be configured as or otherwise support a means for receiving, via the first set of resources, a random access message including the request for the on-demand signaling.

In some examples, to support transmitting the on-demand signaling, the on-demand signaling transmitter 1355 may be configured as or otherwise support a means for transmitting, via the second set of resources, the on-demand signaling that includes a SIB, an SSB, a set of reference signals, a broadcast channel transmission, timing information associated with the on-demand signaling, or a combination thereof. In some examples, to support transmitting the on-demand signaling, the on-demand signaling transmitter 1355 may be configured as or otherwise support a means for transmitting, via the second set of resources, the on-demand signaling that indicates a set of uplink resources, a set of downlink resources, a set of measurement objects, a set of random access resources allocated for reception of random access messages, or a combination thereof. In some examples, the on-demand signaling indicates the set of random access resources, and the retransmission monitoring component 1340 may be configured as or otherwise support a means for receiving a retransmission of a random access message via the set of random access resources indicated by the on-demand signaling.

In some examples, to support transmitting the on-demand signaling, the on-demand signaling transmitter 1355 may be configured as or otherwise support a means for transmitting a set of multiple repetitions of the on-demand signaling via the second set of resources. In some examples, to support transmitting the on-demand signaling, the on-demand signaling transmitter 1355 may be configured as or otherwise support a means for transmitting the on-demand signaling in a second downlink BWP that is different from the first downlink BWP associated with transmission of the system information. In some examples, to support transmitting the on-demand signaling, the on-demand signaling transmitter 1355 may be configured as or otherwise support a means for transmitting the on-demand signaling in the first downlink BWP associated with transmission of the system information.

In some examples, to support transmitting the indication of the second set of resources, the indication transmitter 1350 may be configured as or otherwise support a means for transmitting the indication of a radio resource mapping between the second set of resources and the on-demand signaling, the radio resource mapping associated with a UE capability, a service type, a link quality, or a combination thereof. In some examples, the radio resource mapping indicates one or more of a synchronization raster, a channel raster, or a repetition pattern associated with the UE capability, the service type, the link quality, or a combination thereof.

In some examples, to support transmitting the on-demand signaling, the on-demand signaling transmitter 1355 may be configured as or otherwise support a means for transmitting the on-demand signaling that includes an indication to perform a BWP switching procedure, a carrier switching procedure, a beam switching procedure, an antenna switching procedure, a random backoff procedure, a frequency hopping procedure, or a coverage enhancement procedure.

In some examples, the indication transmitter 1350 may be configured as or otherwise support a means for transmitting an indication that the on-demand signaling, the second set of resources, or both are specific to a UE capability, a service type, a coverage level, a link quality, a contention resolution status, or a combination thereof.

In some examples, to support transmitting the system information, the system information transmitter 1325 may be configured as or otherwise support a means for transmitting the system information indicating the first set of resources for requesting the on-demand signaling, the first set of resources including dedicated resources associated with a UE capability, a service type, a link quality, or a combination thereof.

In some examples, to support transmitting the indication of the second set of resources, the indication transmitter 1350 may be configured as or otherwise support a means for transmitting a paging message in a paging occasion associated with a UE capability, a service type, a link quality, or a combination thereof, where the paging message includes the indication of the second set of resources.

In some examples, the request receiver 1345 may be configured as or otherwise support a means for identifying the request for the on-demand signaling based on monitoring an energy level associated with the first set of resources. In some examples, the request receiver 1345 may be configured as or otherwise support a means for determining that the request corresponds to a UE capability, a service type, a link quality, a contention resolution status, a coverage level, or a combination thereof.

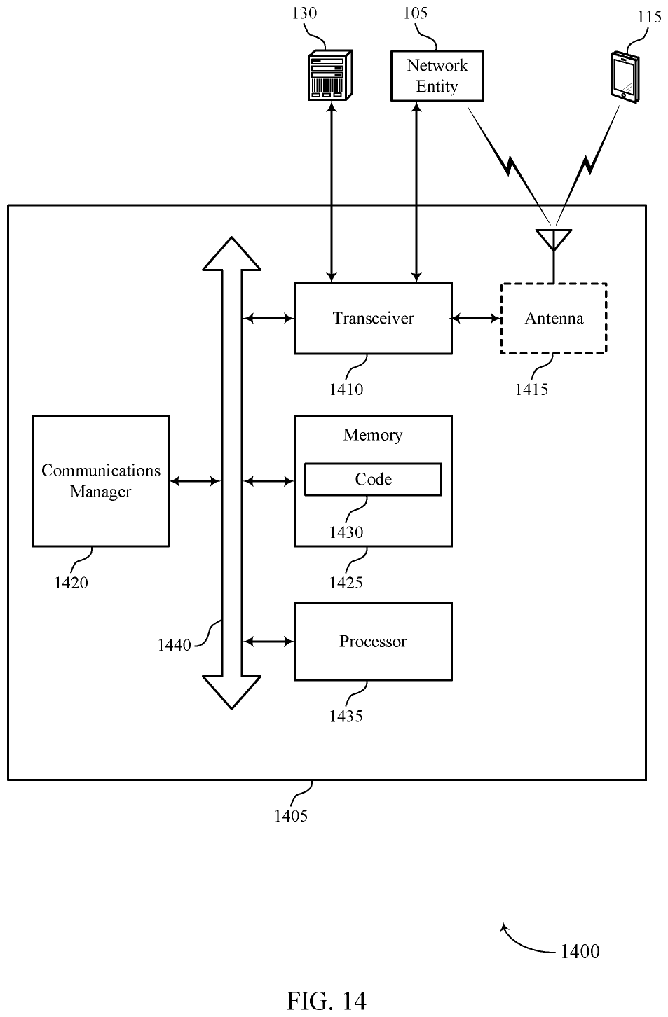

FIG. 14 shows a diagram of a system 1400 including a device 1405 that supports techniques for dynamic resource allocation in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. The transceiver 1410, or the transceiver 1410 and one or more antennas 1415 or wired interfaces, where applicable, may be an example of a transmitter 1115, a transmitter 1215, a receiver 1110, a receiver 1210, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting techniques for dynamic resource allocation). For example, the device 1405 or a component of the device 1405 may include a processor 1435 and memory 1425 coupled (e.g., operatively, communicatively, functionally, electronically, or electrically) with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications at a network entity in accordance with examples as disclosed herein. For example, the communications manager 1420 may be configured as or otherwise support a means for transmitting, in a first downlink BWP, system information indicating a first set of resources allocated for reception of random access messages in a first uplink BWP. The communications manager 1420 may be configured as or otherwise support a means for monitoring the first set of resources for a random access message in accordance with the system information. The communications manager 1420 may be configured as or otherwise support a means for transmitting a RAR based on monitoring the first set of resources, the RAR indicating a second set of resources that are different from the first set of resources. The communications manager 1420 may be configured as or otherwise support a means for monitoring the second set of resources for a retransmission of the random access message in accordance with the RAR.

Additionally, or alternatively, the communications manager 1420 may support wireless communications at a network entity in accordance with examples as disclosed herein. For example, the communications manager 1420 may be configured as or otherwise support a means for transmitting, in a first downlink BWP, system information indicating a first set of resources for requesting transmission of on-demand signaling. The communications manager 1420 may be configured as or otherwise support a means for receiving, in a first uplink BWP and via the first set of resources, a request for the on-demand signaling. The communications manager 1420 may be configured as or otherwise support a means for transmitting an indication of a second set of resources allocated for transmission of the on-demand signaling. The communications manager 1420 may be configured as or otherwise support a means for transmitting the on-demand signaling via the second set of resources in accordance with the indication.

By including or configuring the communications manager 1420 in accordance with examples as described herein, the device 1405 may support more efficient utilization of communication resources during initial access procedures between a UE and the device 1405. More specifically, the techniques and operations described herein may enable the device 1405 to provide the UE with a set of dynamically configured RACH resources, which the UE may use for transmission (or retransmission) of random access messages. Dynamically allocating RACH resources to the UE may enable the UE to perform initial access procedures with fewer collisions, reduced latency, and improved communication reliability, among other benefits. Moreover, the techniques described herein may enable the UE to activate (e.g., trigger) and receive on-demand signaling from the device 1405 during initial access, which may improve the likelihood of successful communications between the UE and the device 1405.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the processor 1435, the memory 1425, the code 1430, the transceiver 1410, or any combination thereof. For example, the code 1430 may include instructions executable by the processor 1435 to cause the device 1405 to perform various aspects of techniques for dynamic resource allocation as described herein, or the processor 1435 and the memory 1425 may be otherwise configured to perform or support such operations.

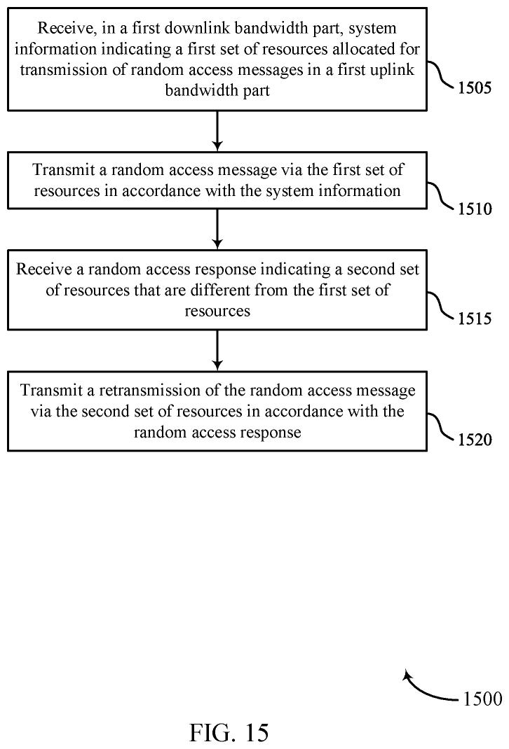

FIG. 15 shows a flowchart illustrating a method 1500 that supports techniques for dynamic resource allocation in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving, in a first downlink bandwidth part, system information indicating a first set of resources allocated for transmission of random access messages in a first uplink bandwidth part. The operations of 1505 may be performed in accordance with examples as disclosed herein. In some examples, aspects of the operations of 1505 may be performed by a system information receiver 925 as described with reference to FIG. 9.

At 1510, the method may include transmitting a random access message via the first set of resources in accordance with the system information. The operations of 1510 may be performed in accordance with examples as disclosed herein. In some examples, aspects of the operations of 1510 may be performed by a random access message transmitter 930 as described with reference to FIG. 9.

At 1515, the method may include receiving a random access response indicating a second set of resources that are different from the first set of resources. The operations of 1515 may be performed in accordance with examples as disclosed herein. In some examples, aspects of the operations of 1515 may be performed by a RAR receiver 935 as described with reference to FIG. 9.

At 1520, the method may include transmitting a retransmission of the random access message via the second set of resources in accordance with the random access response. The operations of 1520 may be performed in accordance with examples as disclosed herein. In some examples, aspects of the operations of 1520 may be performed by a retransmitting component 940 as described with reference to FIG. 9.

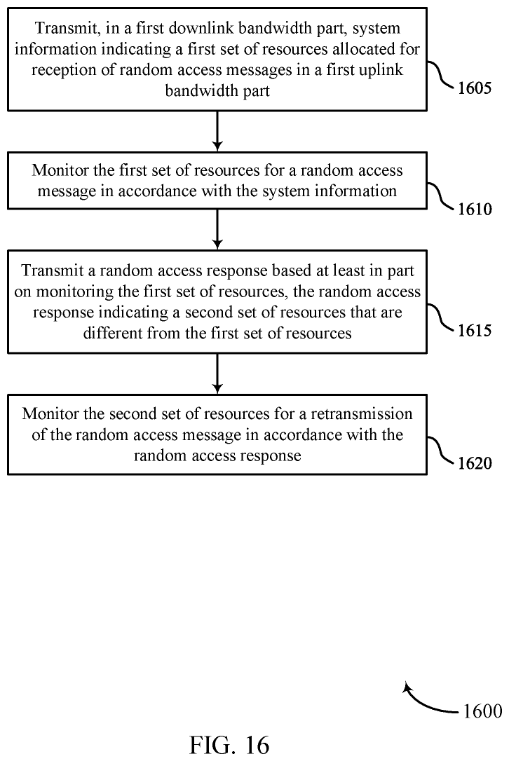

FIG. 16 shows a flowchart illustrating a method 1600 that supports techniques for dynamic resource allocation in accordance with one or more aspects of the present disclosure. The operations of the method 1600 may be implemented by a network entity or its components as described herein. For example, the operations of the method 1600 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, in a first downlink bandwidth part, system information indicating a first set of resources allocated for reception of random access messages in a first uplink bandwidth part. The operations of 1605 may be performed in accordance with examples as disclosed herein. In some examples, aspects of the operations of 1605 may be performed by a system information transmitter 1325 as described with reference to FIG. 13.

At 1610, the method may include monitoring the first set of resources for a random access message in accordance with the system information. The operations of 1610 may be performed in accordance with examples as disclosed herein. In some examples, aspects of the operations of 1610 may be performed by a resource monitoring component 1330 as described with reference to FIG. 13.

At 1615, the method may include transmitting a random access response based at least in part on monitoring the first set of resources, the random access response indicating a second set of resources that are different from the first set of resources. The operations of 1615 may be performed in accordance with examples as disclosed herein. In some examples, aspects of the operations of 1615 may be performed by a RAR transmitter 1335 as described with reference to FIG. 13.

At 1620, the method may include monitoring the second set of resources for a retransmission of the random access message in accordance with the random access response. The operations of 1620 may be performed in accordance with examples as disclosed herein. In some examples, aspects of the operations of 1620 may be performed by a retransmission monitoring component 1340 as described with reference to FIG. 13.

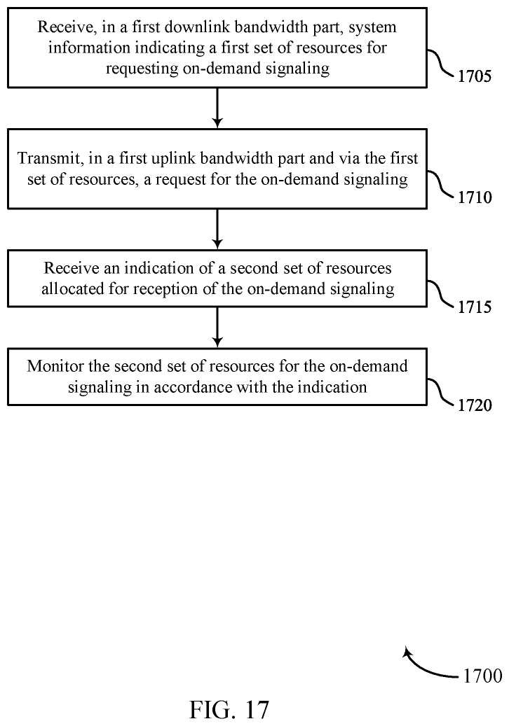

FIG. 17 shows a flowchart illustrating a method 1700 that supports techniques for dynamic resource allocation in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving, in a first downlink bandwidth part, system information indicating a first set of resources for requesting on-demand signaling. The operations of 1705 may be performed in accordance with examples as disclosed herein. In some examples, aspects of the operations of 1705 may be performed by a system information receiver 925 as described with reference to FIG. 9.

At 1710, the method may include transmitting, in a first uplink bandwidth part and via the first set of resources, a request for the on-demand signaling. The operations of 1710 may be performed in accordance with examples as disclosed herein. In some examples, aspects of the operations of 1710 may be performed by a request transmitter 945 as described with reference to FIG. 9.

At 1715, the method may include receiving an indication of a second set of resources allocated for reception of the on-demand signaling. The operations of 1715 may be performed in accordance with examples as disclosed herein. In some examples, aspects of the operations of 1715 may be performed by an indication receiver 950 as described with reference to FIG. 9.

At 1720, the method may include monitoring the second set of resources for the on-demand signaling in accordance with the indication. The operations of 1720 may be performed in accordance with examples as disclosed herein. In some examples, aspects of the operations of 1720 may be performed by a monitoring component 955 as described with reference to FIG. 9.

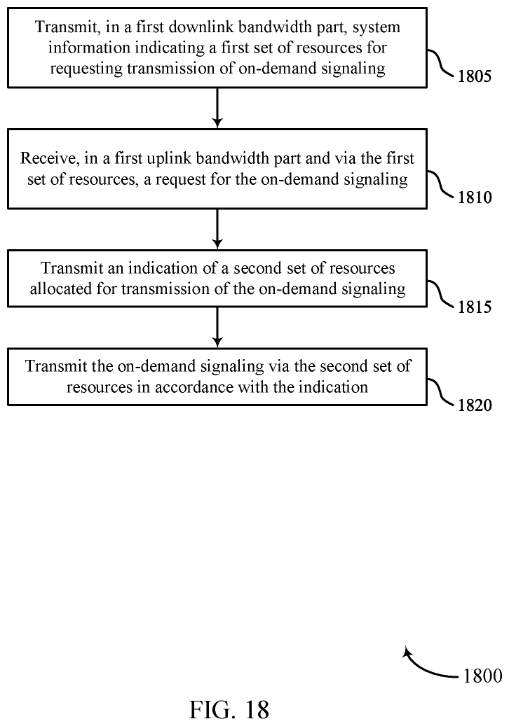

FIG. 18 shows a flowchart illustrating a method 1800 that supports techniques for dynamic resource allocation in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include transmitting, in a first downlink bandwidth part, system information indicating a first set of resources for requesting transmission of on-demand signaling. The operations of 1805 may be performed in accordance with examples as disclosed herein. In some examples, aspects of the operations of 1805 may be performed by a system information transmitter 1325 as described with reference to FIG. 13.

At 1810, the method may include receiving, in a first uplink bandwidth part and via the first set of resources, a request for the on-demand signaling. The operations of 1810 may be performed in accordance with examples as disclosed herein. In some examples, aspects of the operations of 1810 may be performed by a request receiver 1345 as described with reference to FIG. 13.

At 1815, the method may include transmitting an indication of a second set of resources allocated for transmission of the on-demand signaling. The operations of 1815 may be performed in accordance with examples as disclosed herein. In some examples, aspects of the operations of 1815 may be performed by an indication transmitter 1350 as described with reference to FIG. 13.

At 1820, the method may include transmitting the on-demand signaling via the second set of resources in accordance with the indication. The operations of 1820 may be performed in accordance with examples as disclosed herein. In some examples, aspects of the operations of 1820 may be performed by an on-demand signaling transmitter 1355 as described with reference to FIG. 13.

The following provides an overview of aspects of the present disclosure:
Aspect 1: A method for wireless communications at a UE, comprising: receiving, in a first downlink bandwidth part, system information indicating a first set of resources allocated for transmission of random access messages in a first uplink bandwidth part: transmitting a random access message via the first set of resources in accordance with the system information: receiving a random access response indicating a second set of resources that are different from the first set of resources; and transmitting a retransmission of the random access message via the second set of resources in accordance with the random access response.
Aspect 2: The method of aspect 1, wherein receiving the random access response comprises: receiving the random access response indicating the second set of resources and a time duration in which the second set of resources are available for retransmission of random access messages.
Aspect 3: The method of any of aspects 1 through 2, wherein receiving the random access response comprises: receiving the random access response indicating the second set of resources that are multiplexed with the first set of resources in a time domain, a frequency domain, a space domain, or a combination thereof.
Aspect 4: The method of any of aspects 1 through 3, wherein receiving the random access response comprises: receiving the random access response indicating the second set of resources in the first uplink bandwidth part or in a second uplink bandwidth part that is different from the first uplink bandwidth part.
Aspect 5: The method of any of aspects 1 through 4, wherein receiving the random access response comprises: receiving the random access response indicating the second set of resources and a random access signature that comprises one or more of a random access preamble identifier, a UE identifier, or a temporary identifier associated with a random access resource, wherein transmitting the retransmission of the random access message is based at least in part on comparing the random access signature from the random access response to a random access signature associated with the random access message.
Aspect 6: The method of any of aspects 1 through 5, wherein receiving the random access response comprises: receiving the random access response indicating a random access resource pool that comprises the second set of resources, wherein transmitting the retransmission of the random access message via the second set of resources is based at least in part on selecting the second set of resources from the random access resource pool.
Aspect 7: The method of any of aspects 1 through 6, further comprising: receiving a multicast or broadcast downlink control channel transmission indicating one or more resources allocated for reception of the random access response, wherein the multicast or broadcast downlink control channel transmission comprises group-common downlink control information; and monitoring the one or more resources for the random access response in accordance with the multicast or broadcast downlink control channel transmission, wherein the random access response is scrambled using a group identifier.
Aspect 8: The method of any of aspects 1 through 7, wherein transmitting the retransmission of the random access message comprises: transmitting the retransmission of the random access message via the second set of resources in accordance with a power ramping scheme, a beam switching scheme, an antenna switching scheme, a bandwidth part switching scheme, a carrier switching scheme, a random backoff scheme, a frequency hopping scheme, a coverage enhancement scheme, or a combination thereof.
Aspect 9: A method for wireless communications at a network entity, comprising: transmitting, in a first downlink bandwidth part, system information indicating a first set of resources allocated for reception of random access messages in a first uplink bandwidth part: monitoring the first set of resources for a random access message in accordance with the system information: transmitting a random access response based at least in part on monitoring the first set of resources, the random access response indicating a second set of resources that are different from the first set of resources; and monitoring the second set of resources for a retransmission of the random access message in accordance with the random access response.
Aspect 10: The method of aspect 9, wherein transmitting the random access response comprises: transmitting the random access response indicating the second set of resources and a time duration in which the second set of resources are available for retransmission of random access messages.
Aspect 11: The method of any of aspects 9 through 10, wherein transmitting the random access response comprises: transmitting the random access response indicating the second set of resources that are multiplexed with the first set of resources in a time domain, a frequency domain, a space domain, or a combination thereof.
Aspect 12: The method of any of aspects 9 through 11, wherein transmitting the random access response comprises: transmitting the random access response indicating the second set of resources in the first uplink bandwidth part or in a second uplink bandwidth part that is different from the first uplink bandwidth part.
Aspect 13: The method of any of aspects 9 through 12, wherein transmitting the random access response comprises: transmitting the random access response indicating the second set of resources and a random access signature that comprises one or more of a random access preamble identifier, a UE identifier, or a temporary identifier associated with a random access resource.
Aspect 14: The method of any of aspects 9 through 13, wherein transmitting the random access response comprises: transmitting the random access response indicating a random access resource pool that comprises the second set of resources.
Aspect 15: The method of any of aspects 9 through 14, further comprising: transmitting a multicast or broadcast downlink control channel transmission indicating one or more resources allocated for transmission of the random access response, wherein the multicast or broadcast downlink control channel transmission comprises group-common downlink control information; and transmitting the random access response via the one or more resources in accordance with the multicast or broadcast downlink control channel transmission, wherein the random access response is scrambled using a group identifier.
Aspect 16: The method of any of aspects 9 through 15, further comprising: receiving the retransmission of the random access message via the second set of resources in accordance with a power ramping scheme, a beam switching scheme, an antenna switching scheme, a bandwidth part switching scheme, a carrier switching scheme, a random backoff scheme, a frequency hopping scheme, a coverage enhancement scheme, or a combination thereof.
Aspect 17: A method for wireless communications at a UE, comprising: receiving, in a first downlink bandwidth part, system information indicating a first set of resources for requesting on-demand signaling: transmitting, in a first uplink bandwidth part and via the first set of resources, a request for the on-demand signaling: receiving an indication of a second set of resources allocated for reception of the on-demand signaling; and monitoring the second set of resources for the on-demand signaling in accordance with the indication.
Aspect 18: The method of aspect 17, wherein receiving the system information comprises: receiving, in the first downlink bandwidth part, the system information that indicates one or both of the first set of resources or the second set of resources.
Aspect 19: The method of any of aspects 17 through 18, wherein receiving the indication of the second set of resources comprises: receiving a random access response indicating an activation status of the second set of resources, an availability of the second set of resources, or both.
Aspect 20: The method of any of aspects 17 through 19, wherein transmitting the request comprises: transmitting, via the first set of resources, a random access message comprising the request for the on-demand signaling.
Aspect 21: The method of any of aspects 17 through 20, further comprising: receiving, via the second set of resources, the on-demand signaling that comprises a system information block, a synchronization signal block, a set of reference signals, a broadcast channel transmission, timing information associated with the on-demand signaling, or a combination thereof.
Aspect 22: The method of any of aspects 17 through 21, further comprising: receiving, via the second set of resources, the on-demand signaling that indicates a set of uplink resources, a set of downlink resources, a set of measurement objects, a set of random access resources allocated for retransmission of random access messages, or a combination thereof.
Aspect 23: The method of aspect 22, wherein the on-demand signaling indicates the set of random access resources, the method further comprising: transmitting a retransmission of a random access message via the set of random access resources indicated by the on-demand signaling.
Aspect 24: The method of any of aspects 17 through 23, further comprising: receiving a plurality of repetitions of the on-demand signaling via the second set of resources.
Aspect 25: The method of any of aspects 17 through 24, further comprising: receiving the on-demand signaling in the first downlink bandwidth part or in a second downlink bandwidth part that is different from the first downlink bandwidth part.
Aspect 26: The method of any of aspects 17 through 25, wherein receiving the indication of the second set of resources comprises: receiving the indication of a radio resource mapping between the second set of resources and the on-demand signaling, the radio resource mapping associated with a capability of the UE, a service type of the UE, a link quality of the UE, or a combination thereof.
Aspect 27: The method of aspect 26, wherein the radio resource mapping indicates one or more of a synchronization raster, a channel raster, or a repetition pattern associated with the capability of the UE, the service type of the UE, the link quality of the UE, or a combination thereof.
Aspect 28: The method of any of aspects 17 through 27, further comprising: performing one or more of a bandwidth part switching procedure, a carrier switching procedure, a beam switching procedure, an antenna switching procedure, a random backoff procedure, a frequency hopping procedure, or a coverage enhancement procedure based at least in part on receiving the on-demand signaling via the second set of resources.
Aspect 29: The method of any of aspects 17 through 28, further comprising: receiving an indication that the on-demand signaling, the second set of resources, or both are specific to a capability of the UE, a service type of the UE, a coverage level of the UE, a link quality of the UE, a contention resolution status of the UE, or a combination thereof.
Aspect 30: The method of any of aspects 17 through 29, wherein receiving the system information comprises: receiving the system information indicating the first set of resources for requesting the on-demand signaling, the first set of resources comprising dedicated resources associated with a capability of the UE, a service type of the UE, a link quality of the UE, or a combination thereof.
Aspect 31: The method of any of aspects 17 through 30, wherein receiving the indication of the second set of resources comprises: receiving a paging message in a paging occasion associated with a capability of the UE, a service type of the UE, a link quality of the UE, or a combination thereof, wherein the paging message comprises the indication of the second set of resources.
Aspect 32: A method for wireless communications at a network entity, comprising: transmitting, in a first downlink bandwidth part, system information indicating a first set of resources for requesting transmission of on-demand signaling; receiving, in a first uplink bandwidth part and via the first set of resources, a request for the on-demand signaling: transmitting an indication of a second set of resources allocated for transmission of the on-demand signaling; and transmitting the on-demand signaling via the second set of resources in accordance with the indication.
Aspect 33: The method of aspect 32, wherein transmitting the system information comprises: transmitting, in the first downlink bandwidth part, the system information indicating one or both of the first set of resources or the second set of resources.
Aspect 34: The method of any of aspects 32 through 33, wherein transmitting the indication of the second set of resources comprises: transmitting a random access response indicating an activation status of the second set of resources, an availability of the second set of resources, or both.
Aspect 35: The method of any of aspects 32 through 34, wherein receiving the request comprises: receiving, via the first set of resources, a random access message comprising the request for the on-demand signaling.
Aspect 36: The method of any of aspects 32 through 35, wherein transmitting the on-demand signaling comprises: transmitting, via the second set of resources, the on-demand signaling that comprises a system information block, a synchronization signal block, a set of reference signals, a broadcast channel transmission, timing information associated with the on-demand signaling, or a combination thereof.
Aspect 37: The method of any of aspects 32 through 36, wherein transmitting the on-demand signaling comprises: transmitting, via the second set of resources, the on-demand signaling that indicates a set of uplink resources, a set of downlink resources, a set of measurement objects, a set of random access resources allocated for reception of random access messages, or a combination thereof.
Aspect 38: The method of aspect 37, wherein the on-demand signaling indicates the set of random access resources, the method further comprising: receiving a retransmission of a random access message via the set of random access resources indicated by the on-demand signaling.
Aspect 39: The method of any of aspects 32 through 38, wherein transmitting the on-demand signaling comprises: transmitting a plurality of repetitions of the on-demand signaling via the second set of resources.
Aspect 40: The method of any of aspects 32 through 39, wherein transmitting the on-demand signaling comprises: transmitting the on-demand signaling in a second downlink bandwidth part that is different from the first downlink bandwidth part associated with transmission of the system information.
Aspect 41: The method of any of aspects 32 through 39, wherein transmitting the on-demand signaling comprises: transmitting the on-demand signaling in the first downlink bandwidth part associated with transmission of the system information.
Aspect 42: The method of any of aspects 32 through 41, wherein transmitting the indication of the second set of resources comprises: transmitting the indication of a radio resource mapping between the second set of resources and the on-demand signaling, the radio resource mapping associated with a UE capability, a service type, a link quality, or a combination thereof.
Aspect 43: The method of aspect 42, wherein the radio resource mapping indicates one or more of a synchronization raster, a channel raster, or a repetition pattern associated with the UE capability, the service type, the link quality, or a combination thereof.
Aspect 44: The method of any of aspects 32 through 43, wherein transmitting the on-demand signaling comprises: transmitting the on-demand signaling that comprises an indication to perform a bandwidth part switching procedure, a carrier switching procedure, a beam switching procedure, an antenna switching procedure, a random backoff procedure, a frequency hopping procedure, or a coverage enhancement procedure.
Aspect 45: The method of any of aspects 32 through 44, further comprising: transmitting an indication that the on-demand signaling, the second set of resources, or both are specific to a UE capability, a service type, a coverage level, a link quality, a contention resolution status, or a combination thereof.
Aspect 46: The method of any of aspects 32 through 45, wherein transmitting the system information comprises: transmitting the system information indicating the first set of resources for requesting the on-demand signaling, the first set of resources comprising dedicated resources associated with a UE capability, a service type, a link quality, or a combination thereof.
Aspect 47: The method of any of aspects 32 through 46, wherein transmitting the indication of the second set of resources comprises: transmitting a paging message in a paging occasion associated with a UE capability, a service type, a link quality, or a combination thereof, wherein the paging message comprises the indication of the second set of resources.
Aspect 48: The method of any of aspects 32 through 47, further comprising: identifying the request for the on-demand signaling based at least in part on monitoring an energy level associated with the first set of resources; and determining that the request corresponds to a UE capability, a service type, a link quality, a contention resolution status, a coverage level, or a combination thereof.
Aspect 49: An apparatus for wireless communications at a UE, comprising at least one processor: memory coupled with the at least one processor; and instructions stored in the memory and executable by the at least one processor to cause the apparatus to perform a method of any of aspects 1 through 8.
Aspect 50: An apparatus for wireless communications at a UE, comprising at least one means for performing a method of any of aspects 1 through 8.
Aspect 51: A non-transitory computer-readable medium storing code for wireless communications at a UE, the code comprising instructions executable by at least one processor to perform a method of any of aspects 1 through 8.
Aspect 52: An apparatus for wireless communications at a network entity, comprising at least one processor: memory coupled with the at least one processor; and instructions stored in the memory and executable by the at least one processor to cause the apparatus to perform a method of any of aspects 9 through 16.
Aspect 53: An apparatus for wireless communications at a network entity, comprising at least one means for performing a method of any of aspects 9 through 16.
Aspect 54: A non-transitory computer-readable medium storing code for wireless communications at a network entity, the code comprising instructions executable by at least one processor to perform a method of any of aspects 9 through 16.
Aspect 55: An apparatus for wireless communications at a UE, comprising at least one processor: memory coupled with the at least one processor; and instructions stored in the memory and executable by the at least one processor to cause the apparatus to perform a method of any of aspects 17 through 31.
Aspect 56: An apparatus for wireless communications at a UE, comprising at least one means for performing a method of any of aspects 17 through 31.
Aspect 57: A non-transitory computer-readable medium storing code for wireless communications at a UE, the code comprising instructions executable by at least one processor to perform a method of any of aspects 17 through 31.
Aspect 58: An apparatus for wireless communications at a network entity, comprising at least one processor: memory coupled with the at least one processor; and instructions stored in the memory and executable by the at least one processor to cause the apparatus to perform a method of any of aspects 32 through 48.
Aspect 59: An apparatus for wireless communications at a network entity, comprising at least one means for performing a method of any of aspects 32 through 48.
Aspect 60: A non-transitory computer-readable medium storing code for wireless communications at a network entity, the code comprising instructions executable by at least one processor to perform a method of any of aspects 32 through 48.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. At least one processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by at least one processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, etc., whether referred to as software, firmware, middleware, microcode, hardware description language, or otherwise. If implemented in software executed by at least one processor, the functions may be stored on or transmitted over as one or more instructions or code on a computer-readable medium. Other examples and implementations are within the scope of the disclosure and appended claims. For example, due to the nature of software, functions described herein may be implemented using software executed by at least one processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone: B alone: C alone: A and B in combination: A and C in combination: B and C in combination: or A, B, and C in combination.

The term “determine” or “determining” encompasses a variety of actions and, therefore, “determining” can include calculating, computing, processing, deriving, investigating, looking up (such as via looking up in a table, a database or another data structure), or ascertaining. Also, “determining” can include receiving (such as receiving information), or accessing (such as accessing data in a memory). Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communications, comprising:
at least one processor;
memory coupled with the at least one processor; and
instructions stored in the memory and executable by the at least one processor to cause the UE to:
receive, in a first downlink bandwidth part, system information indicating a first set of resources allocated for transmission of random access messages in a first uplink bandwidth part;
transmit a random access message via the first set of resources in accordance with the system information;
receive a random access response indicating a second set of resources that are different from the first set of resources; and
transmit a retransmission of the random access message via the second set of resources in accordance with the random access response.

2. The UE of claim 1, wherein the instructions to receive the random access response are further executable by the at least one processor to cause the UE to:
receive the random access response indicating the second set of resources and a time duration in which the second set of resources are available for retransmission of random access messages.

3. The UE of claim 1, wherein the instructions to receive the random access response are further executable by the at least one processor to cause the UE to:
receive the random access response indicating the second set of resources that are multiplexed with the first set of resources in a time domain, a frequency domain, a space domain, or a combination thereof.

4. The UE of claim 1, wherein the instructions to receive the random access response are further executable by the at least one processor to cause the UE to:
receive the random access response indicating the second set of resources in the first uplink bandwidth part or in a second uplink bandwidth part that is different from the first uplink bandwidth part.

5. The UE of claim 1, wherein the instructions to receive the random access response are further executable by the at least one processor to cause the UE to:
receive the random access response indicating the second set of resources and a random access signature that comprises one or more of a random access preamble identifier, a UE identifier, or a temporary identifier associated with a random access resource, wherein the retransmission of the random access message is transmitted based at least in part on a comparison of the random access signature from the random access response to a random access signature associated with the random access message.

6. The UE of claim 1, wherein the instructions to receive the random access response are further executable by the at least one processor to cause the UE to:
receive the random access response indicating a random access resource pool that comprises the second set of resources, wherein the retransmission of the random access message via the second set of resources is transmitted based at least in part on a selection of the second set of resources from the random access resource pool.

7. The UE of claim 1, wherein the instructions are further executable by the at least one processor to cause the UE to:
receive a multicast or broadcast downlink control channel transmission indicating one or more resources allocated for reception of the random access response, wherein the multicast or broadcast downlink control channel transmission comprises group-common downlink control information; and
monitor the one or more resources for the random access response in accordance with the multicast or broadcast downlink control channel transmission, wherein the random access response is scrambled using a group identifier.

8. The UE of claim 1, wherein the instructions to transmit the retransmission of the random access message are further executable by the at least one processor to cause the UE to:
transmit the retransmission of the random access message via the second set of resources in accordance with a power ramping scheme, a beam switching scheme, an antenna switching scheme, a bandwidth part switching scheme, a carrier switching scheme, a random backoff scheme, a frequency hopping scheme, a coverage enhancement scheme, or a combination thereof.

9. A network entity for wireless communications, comprising:
at least one processor;
memory coupled with the at least one processor; and
instructions stored in the memory and executable by the at least one processor to cause the network entity to:
transmit, in a first downlink bandwidth part, system information indicating a first set of resources allocated for reception of random access messages in a first uplink bandwidth part;
monitor the first set of resources for a random access message in accordance with the system information;
transmit a random access response based at least in part on monitoring the first set of resources, the random access response indicating a second set of resources that are different from the first set of resources; and
monitor the second set of resources for a retransmission of the random access message in accordance with the random access response.

10. The network entity of claim 9, wherein the instructions to transmit the random access response are further executable by the at least one processor to cause the network entity to:
transmit the random access response indicating the second set of resources and a time duration in which the second set of resources are available for retransmission of random access messages.

11. The network entity of claim 9, wherein the instructions to transmit the random access response are further executable by the at least one processor to cause the network entity to:
transmit the random access response indicating the second set of resources that are multiplexed with the first set of resources in a time domain, a frequency domain, a space domain, or a combination thereof.

12. The network entity of claim 9, wherein the instructions to transmit the random access response are further executable by the at least one processor to cause the network entity to:
transmit the random access response indicating the second set of resources in the first uplink bandwidth part or in a second uplink bandwidth part that is different from the first uplink bandwidth part.

13. The network entity of claim 9, wherein the instructions to transmit the random access response are further executable by the at least one processor to cause the network entity to:
transmit the random access response indicating the second set of resources and a random access signature that comprises one or more of a random access preamble identifier, a user equipment (UE) identifier, or a temporary identifier associated with a random access resource.

14. The network entity of claim 9, wherein the instructions to transmit the random access response are further executable by the at least one processor to cause the network entity to:
transmit the random access response indicating a random access resource pool that comprises the second set of resources.

15. The network entity of claim 9, wherein the instructions are further executable by the at least one processor to cause the network entity to:
transmit a multicast or broadcast downlink control channel transmission indicating one or more resources allocated for transmission of the random access response, wherein the multicast or broadcast downlink control channel transmission comprises group-common downlink control information; and
transmit the random access response via the one or more resources in accordance with the multicast or broadcast downlink control channel transmission, wherein the random access response is scrambled using a group identifier.

16. The network entity of claim 9, wherein the instructions are further executable by the at least one processor to cause the network entity to:
receive the retransmission of the random access message via the second set of resources in accordance with a power ramping scheme, a beam switching scheme, an antenna switching scheme, a bandwidth part switching scheme, a carrier switching scheme, a random backoff scheme, a frequency hopping scheme, a coverage enhancement scheme, or a combination thereof.

17. A user equipment (UE) for wireless communications, comprising:
at least one processor;
memory coupled with the at least one processor; and
instructions stored in the memory and executable by the at least one processor to cause the UE to:
receive, in a first downlink bandwidth part, system information indicating a first set of resources for requesting on-demand signaling;
transmit, in a first uplink bandwidth part and via the first set of resources, a request for the on-demand signaling;
receive an indication of a second set of resources allocated for reception of the on-demand signaling; and
monitor the second set of resources for the on-demand signaling in accordance with the indication.

18-23. (canceled)

24. The UE of claim 17, wherein the instructions are further executable by the at least one processor to cause the UE to:
receive a plurality of repetitions of the on-demand signaling via the second set of resources.

25. The UE of claim 17, wherein the instructions are further executable by the at least one processor to cause the UE to:
receive the on-demand signaling in the first downlink bandwidth part or in a second downlink bandwidth part that is different from the first downlink bandwidth part.

26. The UE of claim 17, wherein the instructions to receive the indication of the second set of resources are further executable by the at least one processor to cause the UE to:
receive the indication of a radio resource mapping between the second set of resources and the on-demand signaling, the radio resource mapping associated with a capability of the UE, a service type of the UE, a link quality of the UE, or a combination thereof.

27. (canceled)

28. The UE of claim 17, wherein the instructions are further executable by the at least one processor to cause the UE to:
perform one or more of a bandwidth part switching procedure, a carrier switching procedure, a beam switching procedure, an antenna switching procedure, a random backoff procedure, a frequency hopping procedure, or a coverage enhancement procedure based at least in part on reception of the on-demand signaling via the second set of resources.

29. The UE of claim 17, wherein the instructions are further executable by the at least one processor to cause the UE to:
receive an indication that the on-demand signaling, the second set of resources, or both are specific to a capability of the UE, a service type of the UE, a coverage level of the UE, a link quality of the UE, a contention resolution status of the UE, or a combination thereof.

30. The UE of claim 17, wherein the instructions to receive the system information are further executable by the at least one processor to cause the UE to:
receive the system information indicating the first set of resources for requesting the on-demand signaling, the first set of resources comprising dedicated resources associated with a capability of the UE, a service type of the UE, a link quality of the UE, or a combination thereof.

31. The UE of claim 17, wherein the instructions to receive the indication of the second set of resources are further executable by the at least one processor to cause the UE to:
receive a paging message in a paging occasion associated with a capability of the UE, a service type of the UE, a link quality of the UE, or a combination thereof, wherein the paging message comprises the indication of the second set of resources.

32. A network entity for wireless communications, comprising:
at least one processor;
memory coupled with the at least one processor; and
instructions stored in the memory and executable by the at least one processor to cause the network entity to:
transmit, in a first downlink bandwidth part, system information indicating a first set of resources for requesting transmission of on-demand signaling;
receive, in a first uplink bandwidth part and via the first set of resources, a request for the on-demand signaling;
transmit an indication of a second set of resources allocated for transmission of the on-demand signaling; and
transmit the on-demand signaling via the second set of resources in accordance with the indication.

33-38. (canceled)

39. The network entity of claim 32, wherein the instructions to transmit the on-demand signaling are further executable by the at least one processor to cause the network entity to:
transmit a plurality of repetitions of the on-demand signaling via the second set of resources.

40. The network entity of claim 32, wherein the instructions to transmit the on-demand signaling are further executable by the at least one processor to cause the network entity to:
transmit the on-demand signaling in a second downlink bandwidth part that is different from the first downlink bandwidth part associated with transmission of the system information.

41. The network entity of claim 32, wherein the instructions to transmit the on-demand signaling are further executable by the at least one processor to cause the network entity to:
transmit the on-demand signaling in the first downlink bandwidth part associated with transmission of the system information.

42. The network entity of claim 32, wherein the instructions to transmit the indication of the second set of resources are further executable by the at least one processor to cause the network entity to:
transmit the indication of a radio resource mapping between the second set of resources and the on-demand signaling, the radio resource mapping associated with a user equipment (UE) capability, a service type, a link quality, or a combination thereof.

43-47. (canceled)

48. The network entity of claim 32, wherein the instructions are further executable by the at least one processor to cause the network entity to:
identify the request for the on-demand signaling based at least in part on monitoring an energy level associated with the first set of resources; and
determine that the request corresponds to a user equipment (UE) capability, a service type, a link quality, a contention resolution status, a coverage level, or a combination thereof.

49-60. (canceled)
